(19) United States
(12) Patent Application Publication
(10) Pub. No.: US 2025/0116861 A1
(43) Pub. Date: Apr. 10, 2025

(54) OPTICAL SYSTEM AND IMAGE DISPLAY DEVICE

(71) Applicant: Panasonic Intellectual Property Management Co., Ltd., Osaka (JP)

(72) Inventors: Kazuhiro MINAMI, Osaka (JP); Satoshi KUZUHARA, Osaka (JP)

(21) Appl. No.: 18/984,015

(22) Filed: Dec. 17, 2024

Related U.S. Application Data
(63) Continuation of application No. PCT/JP2023/010426, filed on Mar. 16, 2023.

(30) Foreign Application Priority Data
Jun. 29, 2022 (JP) 2022-105032

(51) Int. Cl. G02B 27/01; B60K 35/23

(52) U.S. Cl. CPC G02B 27/0103; B60K 35/23; B60K 2360/29

(57) ABSTRACT

The optical system includes a light guide including: an incident region allowing an image light ray to enter a body; and an exit extension region including a diffraction structure dividing an image light ray into image light rays and allowing them to emerge from the body. The exit extension region divides the image light ray into first to third image light rays. The first and third image light rays emerge from the exit extension region at different angles to propagate inside the body. The exit extension region includes an overlap part on which the first image light ray and the third image light ray are incident under a condition where they partially overlap with each other. A difference between optical paths of the first image light ray and the third image light ray incident on the overlap part is longer than a coherence length of the image light ray.

### CROSS-REFERENCE TO RELATED APPLICATIONS

The present application is a continuation of PCT/JP2023/010426 filed Mar. 16, 2023, which claims priority to Japanese Patent Application No. 2022-105032, filed on Jun. 29, 2022, the entire contents of which are incorporated herein by reference.

### TECHNICAL FIELD

The present disclosure relates to optical systems and image display devices.

### BACKGROUND ART

Patent literature 1 discloses an optical element (optical system) including a waveguide (light guide) for exit pupil expansion in two directions. The optical element includes three diffractive optical elements (DOE). The first DOE couples a beam from an imager into the waveguide. The second DOE expands the exit pupil in a first direction along a first coordinate axis. The third DOE expands the exit pupil in a second direction along a second coordinate axis, and couples light out of the waveguide.

### CITATION LIST

### Patent Literature

PATENT LITERATURE 1: U.S. Pat. No. 10,429,645 B

### SUMMARY OF INVENTION

### Technical Problem

The optical element disclosed in patent literature 1 is used in an image display device such as a head mounted display. In the image display device, a decrease in a filling factor of a pupil of an image light ray forming an image in a field of view region of a user may cause a decrease in image quality.

The present disclosure provides an optical system and an image display device which can improve a filling factor of a pupil of an image light ray in a field of view region and can reduce a size of an incident region.

### Solution to Problem

An optical system according to one aspect of the present disclosure includes a light guide for guiding an image light ray which is output from a display element and forms an image, to a field of view region of a user as an optical image. The light guide includes: a body having a plate shape; an incident region formed at the body and allowing the image light ray to enter the body so that the image light ray propagates inside the body; and an exit extension region formed at the body and including a diffraction structure dividing an image light ray propagating in a first propagation direction intersecting a thickness direction of the body, into a plurality of image light rays propagating in a second propagation direction intersecting the first propagation direction, in the first propagation direction, and allowing them to emerge from the body. The exit extension region divides an image light ray which propagates in the first propagation direction and is incident on the exit extension region, into a first image light ray, a second image light ray, and a third image light ray, in a predetermined plane including the first propagation direction and the second propagation direction. The first image light ray emerges from the exit extension region at a first angle equal to a propagation angle of an image light ray propagating from the incident region to the exit extension region in the predetermined plane to propagate inside the body. The second image light ray emerges from the exit extension region at a second angle different from the first angle to emerge from the body. The third image light ray emerges from the exit extension region at a third angle different from the first angle and the second angle to propagate inside the body. The exit extension region includes an overlap part on which the first image light ray and the third image light ray are incident under a condition where they partially overlap with each other in the predetermined plane. A difference between optical paths of the first image light ray and the third image light ray incident on the overlap part is longer than a coherence length of the image light ray.

An image display device according to one aspect of the present disclosure includes the above optical system and the display element.

### Advantageous Effects of Invention

The aspects of the present disclosure can improve a filling factor of a pupil of an image light ray in a field of view region and can reduce a size of an incident region.

### BRIEF DESCRIPTION OF DRAWINGS

FIG. 1 is a schematic view of a configuration example of a movable object including an image display device according to one embodiment.

FIG. 2 is an explanatory view of an optical path of an image light ray output from a display element of the image display device of FIG. 1.

FIG. 3 is a perspective view of a configuration example of a light guide of the image display device of FIG. 1.

FIG. 4 is a schematic plan view of the light guide of FIG. 3.

FIG. 5 is a partial schematic sectional view of the light guide of FIG. 3.

FIG. 6 is an explanatory view of a coherence length of an image light ray.

FIG. 7 is an explanatory view of patterns of diffraction of an image light ray by an exit extension region of the light guide of FIG. 3.

FIG. 8 is an explanatory view of one example of diffraction of an image light ray by the exit extension region of the light guide of FIG. 3.

FIG. 9 is an explanatory view of one example of diffraction of an image light ray by the exit extension region of the light guide of FIG. 3.

FIG. 10 is an explanatory view of one example of diffraction of an image light ray by an exit extension region of a light guide of reference example 1.

FIG. 11 is an explanatory view of one example of diffraction of an image light ray by an exit extension region of a light guide of reference example 2.

FIG. 12 is an explanatory view of one example of diffraction of an image light ray by an exit extension region of a light guide of reference example 3.

FIG. 13 is an explanatory view of one example of diffraction of an image light ray by an exit extension region of a light guide of reference example 4.

### DESCRIPTION OF EMBODIMENTS

Hereinafter, embodiments will be described in detail with reference to appropriate drawings. Note that, description more detailed than necessary will be omitted. For example, detailed description of well-known matters or duplicate description of substantially the same components may be omitted. This aims to avoid the following description from becoming more redundant than necessary and to facilitate understanding of persons skilled in the art. The inventor(s) provides the following description and attached drawings for making persons skilled in the art understand the present disclosure only and has no intention to limit subject matters claimed in claims.

A positional relationship such as an upward, downward, left, or right direction is assumed to be based on a positional relationship illustrated in Figures, unless otherwise noted. Figures referred to in the following embodiments are schematic figures. There is no guarantee that size or thickness ratios of individual components in each Figure always reflect actual dimensional ratios thereof. The dimensional ratios of the individual components are not limited to those illustrated in Figures.

In the present disclosure, expressions “travel in ______ direction” and “propagate in ______ direction” used in relation to light rays mean that a light ray forming an image travels in the direction as a whole and therefore light beams included in the light ray forming the image may be permitted to be inclined relative to the ______ direction. For example, regarding a “light ray traveling in ______ direction”, it is sufficient that a main light beam of this light is directed in the ______ direction, and auxiliary beams of this light may be inclined relative to the direction.

### 1. Embodiments

### 1.1 Configuration

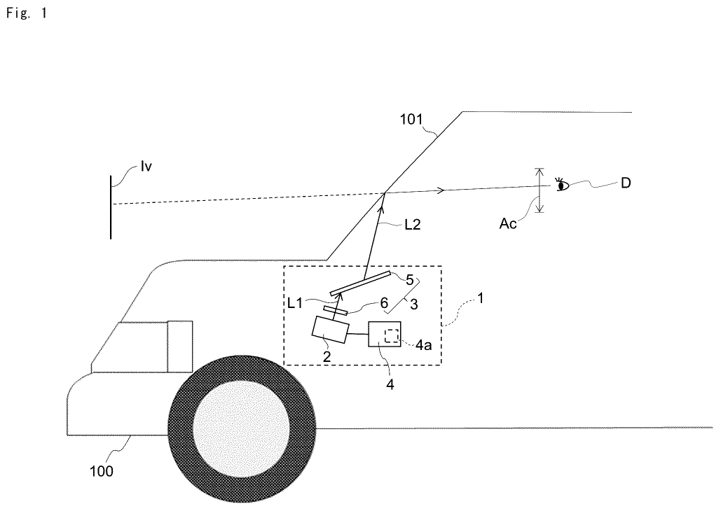

FIG. 1 is a schematic view of a movable object 100 including an image display device 1 according to the present embodiment. The movable object 100 of FIG. 1 is an automobile. Hereinafter, only to facilitate understanding, the movable object 100 may be referred to as the automobile 100. The image display device 1 of FIG. 1 is a head-up display (HUD) to be used in the automobile 100.

The image display device 1 of FIG. 1 is set inside a cabin of the automobile 100 to project an image to a windshield 101 of the automobile 100 from below. In FIG. 1, the image display device 1 is placed inside a dashboard below the windshield 101. When an image is projected from the image display device 1 to the windshield 101, a user D (a driver, or observer) can perceive visually the image reflected by the windshield 101. The user D perceives the image projected by the image display device 1 as a virtual image Iv. Consequently, the image display device 1 displays the virtual image Iv by overlapping it with a real view which can be visually perceived through the windshield 101.

The image display device 1 of FIG. 1 includes a display element 2, an optical system 3, and a control device 4.

The display element 2 is configured to, in order to display an image (picture), output an image light ray L1 for forming an image. Herein, in FIG. 1, only for simplification, the image light ray L1 is depicted as a light ray with directivity but in fact it may be incident on the optical system 3 as a light ray with an angle corresponding to a field of view angle. An optical axis of the display element 2 is an optical axis of the image light ray L1. The optical axis of the image light ray L1 is an optical axis of a light beam output from a center of the display element 2 (i.e., a central light beam of the image light ray L1), for example.

Examples of the display element 2 may include known displays such as liquid crystal displays, organic EL displays, scanning MEMS mirrors, LCOS (Liquid Crystal On Silicon), DMD (Digital Mirror Device), Micro LED, or the like. The image resulting from the image light ray L1 may visually indicate various information such as, road traveling guide indication, a distance to the vehicle ahead, a remaining amount of a vehicle battery, and a current speed of a vehicle.

The optical system 3 is configured to guide the image light ray L1 output from the display element 2 toward a field of view region Ac set relative to eyes of a user. Within the field of view region Ac, the user can watch by his or her own eyes the image formed by the display element 2 with the image not being interrupted. Hereinafter, if necessary, to distinguish an image light ray emerging from the optical system 3 from the image light ray L1 output from the display element 2 toward the optical system 3, the image light ray emerging from the optical system 3 may be denoted by a reference sign L2.

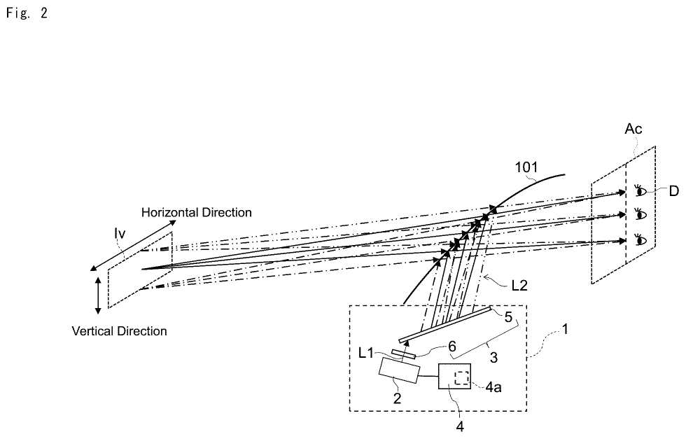

FIG. 2 is an explanatory view of optical paths of image light rays L2 output from the optical system 3 of the image display device 1. In the present embodiment, the optical system 3 expands the field of view region Ac by a pupil expansion effect. In summary, the optical system 3 expands the field of view region Ac by reproducing a pupil of the image light ray L1. In the present embodiment, the field of view region Ac is defined by a rectangular plane. Within the field of view region Ac, the image by the image light ray L1 can be visually perceived even when a position of the user D′ eye is shifted in a horizontal direction or a vertical direction in FIG. 2.

As shown in FIG. 1, the optical system 3 includes a light guide 5 and a projection optical system 6.

The light guide 5 is configured to guide the image light ray L1 which is output from the display element 2 and forms the image, toward the field of view region Ac of the user, as an optical image. In the present embodiment, the optical image is the virtual image Iv.

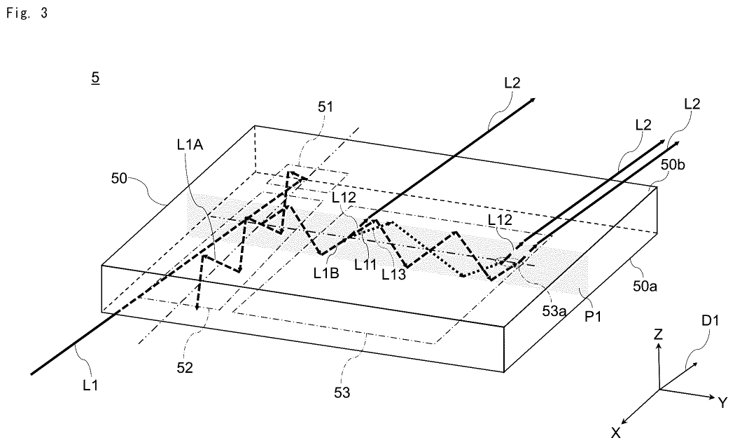

FIG. 3 is a perspective view of a configuration example of the light guide 5. In explanation of the light guide 5, orthogonal coordinates with three axes of XYZ described in FIG. 3 is referred to.

As shown in FIG. 3, the light guide 5 includes a body 50, an incident region 51, an auxiliary extension region 52, and an exit extension region 53.

The body 50 is made of material transparent in a visible light region. The body 50 has a plate shape. In the present embodiment, the body 50 has a rectangular plate shape. The body 50 includes a first surface 50a and a second surface 50b in a thickness direction of the body 50. The thickness direction of the body 50 is a z-axis direction in FIG. 3. The body 50 is positioned or arranged to direct the first surface 50a toward the display element 2 and the second surface 50b toward the field of view region Ac. In this case, the first surface 50a is an incident surface where the image light ray L1 is incident on the body 50, and the second surface 50b is an exit surface where the image light ray L2 emerges from the body 50. In the present embodiment, the light guide 5 is positioned to guide the image light ray L2 emerging from the body 50 to the field of view region Ac as the virtual image Iv by reflecting the image light ray L2 by a light-transmissive member. Therefore, it is possible to allow the user D to watch, from the field of view region Ac, the virtual image Iv by overlapping it with a real view which can be visually perceived through the light-transmissive member. In the present embodiment, the light-transmissive member is the windshield 101 but the light-transmissive member may not be limited to the windshield 101 and may be a member which is transparent in a visible light region (however, is not limited to being colorless and transparent), such as a combiner or the like.

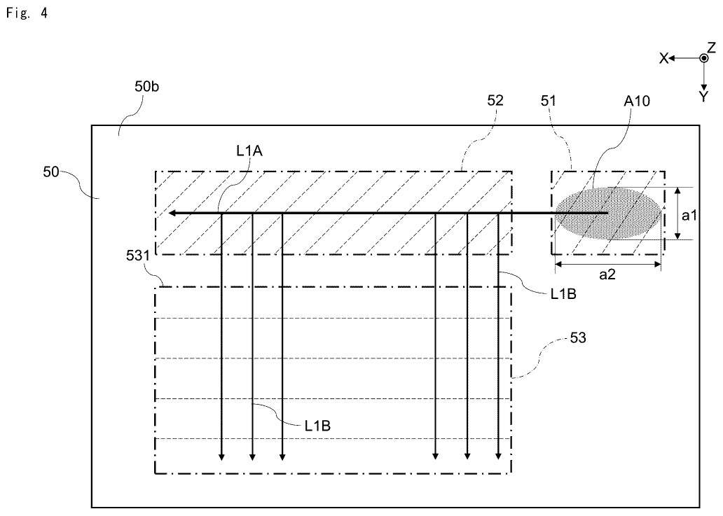

FIG. 4 is a schematic plan view of the light guide 5. Especially, FIG. 4 is a plan view of the light guide 5 when viewed from the second surface 50b. As shown in FIG. 4, the incident region 51, the auxiliary extension region 52, and the exit extension region 53 are formed at the body 50 of the light guide 5.

The incident region 51 is configured to allow the image light ray L1 to enter the body 50 so that the image light ray L1 propagates inside the body 50. In the present embodiment, the incident region 51 allows the image light ray L1 incident on the first surface 50a of the body 50 in a first inclined direction inclined relative to a normal line of the first surface 50a of the body 50, to enter the body 50 so that the image light ray L1 propagates inside the body 50. In the present embodiment, the first inclined direction is a direction represented by D1 in FIG. 3. In the present embodiment, the incident region 51 allows the image light ray L1 to enter the body 50 so that the image light ray L1 propagates inside the body 50 in a predetermined direction (a positive direction on the X axis) in a plane perpendicular to the thickness direction of the body 50 (in the XY plane). In FIG. 4, an image light ray propagating in the positive direction on the X axis is denoted by a reference sign LIA. In the present embodiment, the incident region 51 is used for coupling between the display element 2 and the light guide 5. The incident region 51 allows the image light ray L1 to be incident on the body 50 and propagate within the body 50 under a total reflection condition. The term “coupling” used herein means allowing propagation inside the body 50 of the light guide 5 under a total reflection condition.

The incident region 51 is constituted by a diffraction structure (periodic structure) causing diffraction effect for the image light ray L1. The diffraction structure of the incident region 51 is, for example, a volume holographic element (holographic diffraction grating). The volume holographic element causes diffraction effect owing to a periodic modulation of a refractive index. A diffraction pitch (diffraction period) of the volume holographic element indicates a period of change in the refractive index of the volume holographic element. The diffraction period of the volume holographic element may be defined by a distance between parts with the maximum refractive index or the minimum refractive index of the volume holographic element, for example. The incident region 51 is formed inside the body 50, for example.

The incident region 51 causes diffraction effect to allow the image light ray L1 to enter the body 50 to be reflected by the first surface 50a and the second surface 50b under a total reflection condition. Owing to the incident region 51, the image light ray L1 travels in the positive direction of the X axis inside the body 50 by being totally reflected by the first surface 50a and the second surface 50b.

A size of the incident region 51 is set to allow part or a whole of the image light ray L1 from the display element 2 through the projection optical system 6 to be incident on the incident region 51. In the present embodiment, as shown in FIG. 4, the incident region 51 has a quadrilateral shape.

The auxiliary extension region 52 is positioned to be arranged in a predetermined direction (the positive direction of the X axis) side by side with the incident region 51. The auxiliary extension region 52 is constituted by a diffraction structure (periodic structure) causing diffraction effect for the image light ray L1A. The diffraction structure of the auxiliary extension region 52 is a volume holographic element (holographic diffraction grating), for example. The auxiliary extension region 52 is formed inside the body 50, for example.

The auxiliary extension region 52 changes a traveling direction of the image light ray L1A to a first propagation direction and divides the image light ray L1A into a plurality of image light rays. The first propagation direction is a direction intersecting the predetermined direction within a plane perpendicular to the thickness direction of the body 50 (the XY plane). For example, the first propagation direction is a positive direction of the Y axis. In FIG. 4, the image light rays propagating in the positive direction of the Y axis are denoted by a reference sign L1B. Accordingly, the auxiliary extension region 52 is configured to divide the image light ray L1A propagating in the predetermined direction, into the plurality of image light rays L1B propagating in the first propagation direction, in the predetermined direction. The auxiliary extension region 52 allows the plurality of image light rays L1B arranged in the predetermined direction (the positive direction of the X axis) to travel toward the exit extension region 53, by dividing the image light ray L1A propagating inside the body 50 of the light guide 5. By doing so, the auxiliary extension region 52 realizes pupil expansion of the image light ray L1 in the predetermined direction (the positive direction of the X axis). In summary, as shown in FIG. 4, the auxiliary extension region 52 reproduces in the predetermined direction (the positive direction of the X axis), the pupil of the image light ray L1 projected by the projection optical system 6 to expand the pupil by dividing the image light ray L1A into the plurality of image light rays L1B which are substantially parallel to each other and travel toward the exit extension region 53.

A size of the auxiliary extension region 52 is set to allow the image light ray L1A from the incident region 51 to be incident on the auxiliary extension region 52. In one example, a dimension in the Y axis of an end on a side of the incident region 51 (the right end in FIG. 4), of the auxiliary extension region 52 is set to allow a whole of the image light ray L1A diffracted by the incident region 51 to be incident on the auxiliary extension region 52. In the present embodiment, as shown in FIG. 4, the auxiliary extension region 52 has a quadrilateral shape.

The exit extension region 53 is positioned to be arranged in the first propagation direction (the positive direction of the Y axis) side by side with the auxiliary extension region 52. The exit extension region 53 is constituted by a diffraction structure (periodic structure) causing diffraction effect for the image light ray L1B. The diffraction structure of the exit extension region 53 is a volume holographic element (holographic diffraction grating), for example. The exit extension region 53 is formed inside the body 50, for example.

The exit extension region 53 changes a traveling direction of the image light ray L1B to a second propagation direction and divides the image light ray L1B into a plurality of image light rays. The second propagation direction is a direction from the body 50 toward the field of view region Ac. In FIG. 3, the image light rays propagating in the second propagation direction are denoted by a reference sign L1C. The exit extension region 53 allows the plurality of image light rays L1C propagating in the second propagation direction to emerge from the second surface 50b of the body 50 in a second inclined direction inclined relative to a normal line of the second surface 50b of the body 50. In FIG. 3, the image light rays propagating in the second inclined direction are denoted by a reference sign L2. In the present embodiment, the second inclined direction is a direction denoted by D1 in FIG. 3. Therefore, the first inclined direction and the second inclined direction are parallel to each other. Accordingly, the exit extension region 53 is configured to divide the image light ray L1B propagating in the first propagation direction, into the plurality of image light rays L2 propagating in the second propagation direction and emerging from the second surface 50b of the body 50 in the second inclined direction, in the first propagation direction. The exit extension region 53 allows the plurality of image light rays L2 arranged in the first propagation direction (the positive direction of the Y axis) to travel toward the field of view region Ac, by dividing the image light ray L1B propagating inside the body 50 of the light guide 5. By doing so, the exit extension region 53 realizes pupil expansion of the image light ray L1 in the first propagation direction (the positive direction of the Y axis). In summary, as shown in FIG. 3, the exit extension region 53 reproduces in the first propagation direction (the positive direction of the Y axis), the pupil of the image light ray L1 projected by the projection optical system 6 to expand the pupil by dividing the image light ray L1B into the plurality of image light rays L2 which are substantially parallel to each other and travel toward the field of view region Ac.

As described above, the auxiliary extension region 52 and the exit extension region 53 reproduce the pupil of the image light ray L1 to expand the pupil, by dividing the image light ray L1 entering the body 50 of the light guide 5 via the incident region 51 into the plurality of image light rays L1 in the predetermined direction (the positive direction of the X axis) and the first propagation direction (the positive direction of the Y axis). In the present embodiment, the predetermined direction corresponds to the horizontal direction of the field of view region Ac, and the first propagation direction corresponds to a vertical direction of the field of view region Ac. In the present embodiment, the auxiliary extension region 52 and the exit extension region 53 reproduce the pupil of the image light ray L1 to expand the pupil, by dividing the image light ray L1 entering the body 50 of the light guide 5 via the incident region 51 into the plurality of image light rays L2 and allowing them to emerge toward the field of view region Ac. In the present embodiment, the plurality of light image rays L2 are parallel to each other. The expression “the plurality of image light rays L2 are parallel to each other” is not limited to meaning that the plurality of image light rays L2 are parallel to each other in a strict sense, but includes meaning that the plurality of image light rays L2 are substantially parallel to each other. When the plurality of image light rays L2 are not parallel to each other in a strict sense, it is sufficient that directions of the plurality of image light rays L2 are aligned to an extent that the plurality of image light rays L2 are considered to be parallel to each other in view of an optical design. When the plurality of image light rays L2 are parallel to each other, it is possible to improve uniformity of arrangement of the pupil of the image light ray in the field of view region Ac and this can increase a filling factor. As the filing factor of the pupil becomes smaller, a difference between light and dark areas in the optical image (the virtual image Iv) viewed from the field of view region Ac becomes larger. This may cause a decrease in image quality. By improving the filing factor of the pupil of the image light ray in the field of view region Ac, the image quality of the optical image (the virtual image Iv) can be improved.

In the present embodiment, as shown in FIG. 2, the plurality of image light rays L2 travel toward the field of view region Ac by being reflected by the windshield 101. The light guide 5 may be configured to allow the plurality of image light rays L2 traveling toward the field of view region Ac by being reflected by the windshield 101 to be parallel to each other. In a case where the windshield 101 has a curved surface as shown in FIG. 2, the image light rays L2 may have different incident angles and different reflection angles depending on positions in a surface of the windshield 101 even when directions thereof toward the windshield 101 are identical to each other. Accordingly, the light guide 5 is configured to allow the plurality of image light ray L2 not to be parallel to each other after emerging from the light guide 5 before being incident on the windshield 101, and to be parallel to each other by being reflected by the windshield 101. In other hand, in a case where the windshield 101 has a flat surface, the image light rays L2 may have the same incident angle and the same reflection angle regardless of positions in a surface of the windshield 101 only when directions thereof toward the windshield 101 are identical to each other. Therefore, the light guide 5 may be configured to enable the plurality of image light ray L2 to be parallel to each other and emerge from the light guide 5.

Especially, in the present embodiment, as shown in FIG. 3, the exit extension region 53 divides the image light ray L1B which propagates in the first propagation direction and is incident on the exit extension region 53, into a first image light ray L11, a second image light ray L12, and a third image light ray L13, in a predetermined plane P1 including the first propagation direction and the second propagation direction. The predetermined plane P1 corresponds to the YZ plane in FIG. 3.

Part of the exit extension region 53 which divides the image light ray L1B into the first image light ray L11, the second image light ray L12 and the third image light ray L13 may be any part of the exit extension region 53 but preferably it may be included in an end on a side of the incident region 51, of the exit extension region 53 in an optical path of the image light ray L1 from the incident region 51 to the exit extension region 53. In the present embodiment, the optical path of the image light ray L1 from the incident region 51 to the exit extension region 53 passes through the auxiliary extension region 52. Therefore, “an end on a side of the incident region 51, of the exit extension region 53 in an optical path of the image light ray L1 from the incident region 51 to the exit extension region 53” is not an end in the negative direction of the X axis but an end in the negative direction of the Y axis, of the exit extension region 53 in FIG. 4. Herein, the end on the side of the incident region 51, of the exit extension region 53 may be a region which occupies a quarter of the exit extension region 53 in the first propagation direction from an end 531 on the side of the incident region 51, of the exit extension region 53. The end on the side of the incident region 51, of the exit extension region 53 in the optical path of the image light ray L1 from the incident region 51 to the exit extension region 53 is an end on an incident side of an image light ray of the exit extension region 53 and therefore a part of the exit extension region 53 which may see a large amount of the image light ray LIB incident on the exit extension region 53. Accordingly, the third image light ray L13 is produced at the part which sees a large amount of the image light ray L1B incident on the exit extension region 53 and thus it is possible to improve the filling factor of the pupil of the image light ray L1 2 efficiently. In particular, the exit extension region 53 may preferably divide at least the image light ray L1B which is incident on the exit extension region 53 from the incident region 51 first time, into the first image light ray L11, the second image light ray L12 and the third image light ray L13. Of course, the light guide 5 may divide the image light ray L1B into the first image light ray L11, the second image light ray L12 and the third image light ray L13, at a plurality of parts thereof.

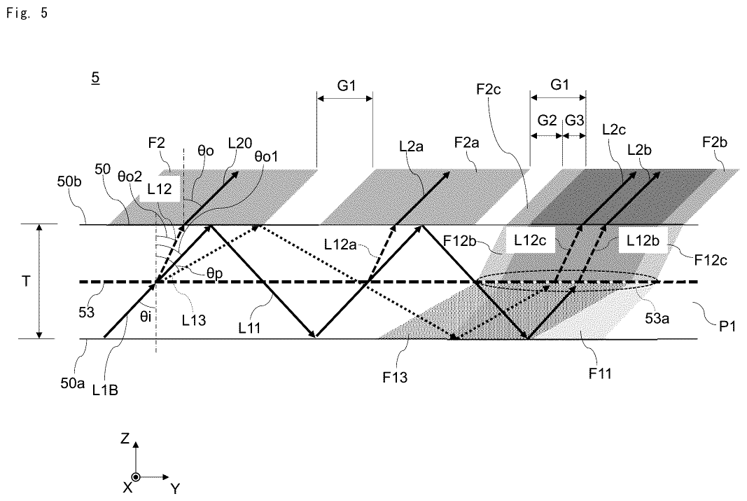

FIG. 5 is a partial schematic sectional view of the light guide 5. In particular, FIG. 5 is a schematic sectional view of, part, including the exit extension region 53, of the body 50 of the light guide 5, in the predetermined plane P1. In FIG. 5, the image light ray L1B is incident on the exit extension region 53 from a side of the first surface 50a of the body 50.

The first image light ray L11 of FIG. 5 emerges from the exit extension region 53 at a first angle θ_{o 1}. The first angle θ_{o 1} satisfies a condition of propagation inside the body 50 by total reflection, and therefore the first image light ray L11 of FIG. 5 propagates inside the body 50 in the first propagation direction (the positive direction of the Y axis) under a total reflection condition. The first angle θ_{o 1} is equal to a propagation angle θᵢ of the image light ray L1 propagating from the incident region 51 to the exit extension region 53 in the predetermined plane P1. In the present embodiment, on the optical path of the image light ray L1, positioned between the incident region 51 and the exit extension region 53 is the auxiliary extension region 52 and therefore the propagation angle θᵢ corresponds to a propagation angle of the image light ray L1B propagating from the auxiliary extension region 52 to the exit extension region 53. The first image light ray L11 of FIG. 5 corresponds to a zero-order diffraction light relative to the image light ray L1B.

The second image light ray L12 of FIG. 5 emerges from the exit extension region 53 at a second angle θ_{o 2}. The second angle θ_{o 2} is different from the first angle θ_{o 1}. The second angle θ_{o 2} does not satisfy the condition of propagation inside the body 50 by total reflection, and therefore the second image light ray L12 of FIG. 5 emerges from the body 50. In the present embodiment, the second image light ray L12 is diffracted when it emerges from the second surface 50b of the body 50, and thus emerges as the image light ray L20. The second image light ray L12 of FIG. 5 corresponds to a first positive order diffraction light relative to the image light ray L1B.

The third image light ray L13 of FIG. 5 emerges from the exit extension region 53 at a third angle θₚ. The third angle θₚ is different from the first angle θ_{o 1} and the second angle θ_{o 2}. The third angle θₚ satisfies the condition of propagation inside the body 50 by total reflection, and therefore the third image light ray L13 of FIG. 5 propagates inside the body 50 in the first propagation direction (the positive direction of the Y axis) under a total reflection condition. The third image light ray L13 of FIG. 5 corresponds to a −1st (first negative order) diffraction light relative to the image light ray L1B.

As to the exit extension region 53, the second image light ray L12 emerges from the body 50 and finally reaches the field of view region Ac as the image light ray L20. In contrast, the first image light ray L11 and the third image light ray L13 propagate inside the body 50 in the first propagation direction (the positive direction of the Y axis) under a total reflection condition. Therefore, the first image light ray L11 and the third image light ray L13 may be diffracted by the diffraction structure of the exit extension region 53. This means that the first image light ray L11 and the third image light ray L13 each may be divided into an additional new first image light ray L11, an additional new second image light ray L12 and an additional new third image light ray L13.

In FIG. 5, the description is focused on the first image light ray L11. After emerging from the exit extension region 53, the first image light ray L11 is totally reflected by the second surface 50b of the body 50, and thereafter passes through the exit extension region 53, and then is totally reflected by the first surface 50a of the body 50, and subsequently is incident on the exit extension region 53 from the side of the first surface 50a of the body 50. The first image light ray L11 is divided by the exit extension region 53 into a first image light ray, a second image light ray, and a third image light ray. The expression “the first image light ray L11 is divided into a first image light ray” may mean that the first image light ray L11 goes through the exit extension region 53 without any change in its direction. Accordingly, part of the first image light ray L11 goes straight without any change in its direction, and other part of the first image light ray L11 changes its direction to be the second image light ray L12a and further other part of the first image light ray L11 changes its direction to be the third image light ray (illustration thereof is omitted in FIG. 5). The second image light ray L12a is diffracted when emerging from the second surface 50b of the body 50 and thus emerges as the image light ray L2a.

Additionally, the first image light ray L11 going straight in the exit extension region 53 without any change in its direction is totally reflected by the second surface 50b of the body 50, and thereafter passes through the exit extension region 53, and then is totally reflected by the first surface 50a of the body 50, and subsequently is incident on the exit extension region 53 again from the side of the first surface 50a of the body 50. The first image light ray L11 is divided by the exit extension region 53 into a first image light ray, a second image light ray, and a third image light ray. Accordingly, part of the first image light ray L11 goes straight without any change in its direction, and other part of the first image light ray L11 changes its direction to be the second image light ray L12b and further other part of the first image light ray L11 changes its direction to be the third image light ray (illustration thereof is omitted in FIG. 5). The second image light ray L12b is diffracted when emerging from the second surface 50b of the body 50 and thus emerges as the image light ray L2b.

In FIG. 5, the description is focused on the third image light ray L13. After emerging from the exit extension region 53, the third image light ray L13 is totally reflected by the second surface 50b of the body 50, and thereafter passes through the exit extension region 53, and then is totally reflected by the first surface 50a of the body 50, and subsequently is incident on the exit extension region 53 from the side of the first surface 50a of the body 50. The third image light ray L13 is divided by the exit extension region 53 into a first image light ray, a second image light ray, and a third image light ray. The expression “the third image light ray L13 is divided into a third image light ray” may mean that the third image light ray L13 goes through the exit extension region 53 without any change in its direction. Accordingly, part of the third image light ray L13 goes straight without any change in its direction, and other part of the third image light ray L13 changes its direction to be the second image light ray L12c and further other part of the third image light ray L13 changes its direction to be the first image light ray (illustration thereof is omitted in FIG. 5). The second image light ray L12c is diffracted when emerging from the second surface 50b of the body 50 and thus emerges as the image light ray L2c. Relative to the third image light ray L13, the first image light ray corresponds to a first positive order diffraction light and the second image light ray corresponds to a second positive order diffraction light.

In FIG. 5, central light beams of the individual image light rays L1B, L11, L12, L12a, L12b, L12c, L13, L20, L2a, L2b, and L2b are represented by arrows. As described above, actually the image light ray L1 is a light ray with an angle corresponding to a field of view angle. In FIG. 5, regarding part of the image light rays L11 and L13 as well as the image light rays L12b, L12c, L20, L2a, L2b, L2c, their widths or ranges F11, F13, F12b, F12c, F2, F2a, F2b, and F2c are depicted in addition to their central light beam.

In FIG. 5, the exit extension region 53 allows the plurality of image light rays L20, L2a, L2b, L2c to emerge from the second surface 50b of the body 50. Intervals between the plurality of image light rays L20, L2a and L2b are equal to each other, and gaps G1 between widths of adjacent image light rays of the plurality of image light rays L20, L2a and L2b are equal to each other. A decrease in the gaps G1 enables improvement of the filling factor of the pupil of the image light ray L1 in the field of view region Ac.

The exit extension region 53 of FIG. 5 includes an overlap part 53a on which the first image light ray L11 and the third image light ray L13 are incident under a condition where they partially overlap with each other in the predetermined plane P1. Accordingly, the second image light ray L12b divided from the first image light ray L11 in the overlap part 53a and the second image light ray L12c divided from the third image light ray L13 in the overlap part 53a also overlap with each other, and are made to emerge outside from the second surface 50b of the body 50 as the image light rays L2b, L2c. Therefore, the image light rays L2b and L2c also partially overlap with each other. In FIG. 5, the image light ray L2c is closer to the image light ray L2a than the image light ray L2b is. The gap G2 between the ranges F2a and F2c of the image light rays L2a and L2c is narrower than the gap G1 between the ranges F2a and F2b of the image light rays L2a and L2b. Each of the plurality of image light rays L20, L2a, L2b, and L2c is the image light ray L2. Therefore, substantially the gaps between the image light rays L2 become narrower. This enables improvement of the filling factor of the pupil of the image light ray L1 in the field of view region Ac. A difference G3 between the gap G1 and the gap G2 is equal to a distance between incident positions of the first image light ray L11 and the third image light ray L13 at the overlap part 53a.

In the overlap part 53a, the image light rays L2b and L2c partially overlap with each other. Therefore, there is a possibility that the image light rays L2b and L2c interfere with each other. When the image light rays L2b and L2c interfere with each other, image quality of the virtual image Iv may be deteriorated. To address this, the exit extension region 53 is set to allow a difference between optical paths of the first image light ray L11 and the third image light ray L13 incident on the overlap part 53a to be longer than a coherence length of the image light ray L1. This can reduce a possibility of occurrence of interference between the image light rays L2b and L2c and thus can reduce a decrease in the image quality of the virtual image Iv.

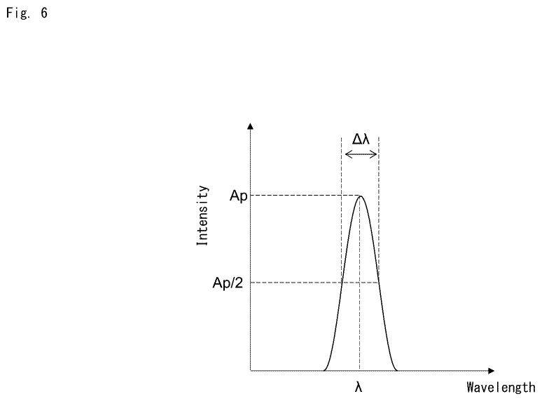

FIG. 6 is an explanatory view of the coherence length of the image light ray L1. In FIG. 6, λ is a central wavelength [μm] of the image light ray L1, and Ax is a line width [μm] of the image light ray L1. In the present embodiment, the line width is a full width at half maximum of a spectrum of the image light ray L1. In other words, the line width is a width of a spectrum when an intensity of the image light ray L1 is Ap/2 which is a half of the maximum value Ap. In vacuum, the coherence length is given by λ²/Δλ. When the refractive index of the body 50 of the light guide 5 is n, the coherence length of the image light ray L1 inside the body 50 is (λ/n)²/(Δλ/n).

In FIG. 5, just one overlap part 53a is depicted, but the exit extension region 53 may include two or more overlap parts 53a.

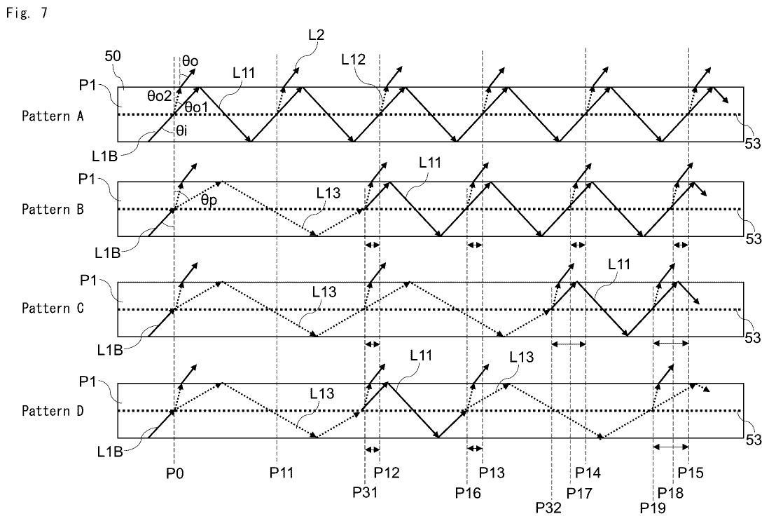

FIG. 7 is an explanatory view of patterns of diffraction of an image light ray by the exit extension region 53 of the light guide 5 of FIG. 3. FIG. 7 illustrates patterns A to D in the aforementioned predetermined plane P1. In the pattern A to D, a position P0 means a position where the image light ray L1B first incident on the exit extension region 53. At the position P0, the image light ray L1Bb is divided into the first image light ray L11, the second image light ray L12 and the third image light ray L13.

The pattern A of FIG. 7 shows that the first image light ray L11 propagates inside the body 50. In the pattern A, the first image light ray L11 emerges from the exit extension region 53, and then is totally reflected between the first surface 50a and the second surface 50b of the body 50 to propagate inside the body 50 in the first propagation direction. The first image light ray L11 is incident on the exit extension region 53 from the side of the first surface 50a of the body 50 at each of positions P11, P12, P13, P14, and P15 and then is divided into the first image light ray L11, the second image light ray L12 and the third image light ray (not shown). In the pattern A, the second image light rays L12 from the positions P11, P12, P13, P14, and P15 are extracted outside from the second surface 50b of the body 50 as the image light rays L2.

The patterns B to D of FIG. 7 show that the third image light ray L13 propagates inside the body 50. In the patterns B to D, the third image light ray L13 emerges from the exit extension region 53, and then is totally reflected between the first surface 50a and the second surface 50b of the body 50 to propagate inside the body 50 in the first propagation direction.

In the patterns B to D, the third image light ray L13 is incident on the exit extension region 53 from the side of the first surface 50a of the body 50 at a position P31 and then is divided into the first image light ray L11, the second image light ray L12 and the third image light ray L13.

In the patterns B and D, the first image light ray L11 divided from the third image light ray L13 at the position P31 emerges from the exit extension region 53, and then is totally reflected between the first surface 50a and the second surface 50b of the body 50 to propagate inside the body 50 in the first propagation direction. Thereafter, the third image light ray L13 is incident on the exit extension region 53 from the side of the first surface 50a of the body 50 at a position P16 and then is divided into the first image light ray L11, the second image light ray L12 and the third image light ray L13.

In the pattern B, the first image light ray L11 divided from the third image light ray L13 at the position P16 emerges from the exit extension region 53, and then is totally reflected between the first surface 50a and the second surface 50b of the body 50 to propagate inside the body 50 in the first propagation direction. The first image light ray L11 is incident on the exit extension region 53 from the side of the first surface 50a of the body 50 at each of positions P17 and P18 and then is divided into the first image light ray L11, the second image light ray L12 and the third image light ray (not shown). In the pattern B, the second image light rays L12 from the positions P31, P16, P17, and P18 are extracted outside from the second surface 50b of the body 50 as the image light rays L2.

In the pattern D, the third image light ray L13 emerges from the exit extension region 53 at the position P16, and then is totally reflected between the first surface 50a and the second surface 50b of the body 50 to propagate inside the body 50 in the first propagation direction. The third image light ray L13 is incident on the exit extension region 53 from the side of the first surface 50a of the body 50 at a position P19 and then is divided into the first image light ray (not shown), the second image light ray L12 and the third image light ray L13. In the pattern D, the second image light rays L12 from the positions P31, P16, and P19 are extracted outside from the second surface 50b of the body 50 as the image light rays L2.

In the pattern C, the third image light ray L13 emerges from the exit extension region 53 at the position P31, and then is totally reflected between the first surface 50a and the second surface 50b of the body 50 to propagate inside the body 50 in the first propagation direction. After that, the third image light ray L13 is incident on the exit extension region 53 from the side of the first surface 50a of the body 50 at a position P32 and then is divided into the first image light ray L11, the second image light ray L12 and the third image light ray (not shown). In the pattern C of FIG. 7, the first image light ray L11 divided from the third image light ray L13 at the position P32 emerges from the exit extension region 53, and then is totally reflected between the first surface 50a and the second surface 50b of the body 50 to propagate inside the body 50 in the first propagation direction. The first image light ray L11 is incident on the exit extension region 53 from the side of the first surface 50a of the body 50 at a position P19 and then is divided into the first image light ray L11, the second image light ray L12 and the third image light ray (not shown). In the pattern C, the second image light rays L12 from the positions P31, P32, and P19 are extracted outside from the second surface 50b of the body 50 as the image light rays L2.

In FIG. 7, there is a possibility that the first image light ray L11 incident on the position P12 and the third image light ray L13 incident on the position P31 partially overlap with each other in the predetermined plane P1. This means that the overlap part 53a may exist in a range containing the positions P12 and P31. In FIG. 7, there is a possibility that the first image light ray L11 incident on the position P14 and the third image light ray L13 incident on the position P32 partially overlap with each other in the predetermined plane P1. This means that the overlap part 53a may exist in a range containing the positions P14 and P32. In FIG. 7, there is a possibility that the first image light ray L11 incident on the position P15 and the third image light ray L13 incident on the position P19 partially overlap with each other in the predetermined plane P1. This means that the overlap part 53a may exist in a range containing the positions P15 and P19.

In FIG. 7, there is a possibility that the first image light ray L11 incident on the position P13 and the first image light ray L11 incident on the position P16 partially overlap with each other in the predetermined plane P1. In FIG. 7, there is a possibility that the first image light ray L11 incident on the position P14 and the first image light ray L11 incident on the position P17 partially overlap with each other in the predetermined plane P1. In FIG. 7, there is a possibility that the first image light ray L11 incident on the position P15 and the first image light ray L11 incident on the position P18 or the position P19 partially overlap with each other in the predetermined plane P1. This means that the exit extension region 53 may include, in addition to the overlap part 53a on which the first image light ray L11 and the third image light ray L13 are incident under a condition where the first image light ray L11 and the third image light ray L13 partially overlap with each other in the predetermined plane P1, an overlap part on which the first image light ray L11 and the first image light ray L11 divided from the third image light ray L13 are incident under a condition where the first image light ray L11 and the first image light ray L11 divided from the third image light ray L13 partially overlap with each other in the predetermined plane P1. Thus, the exit extension region 53 may include an overlap part on which the first or third image light ray divided from the first image light ray L11 and the first or third image light ray divided from the third image light ray L13 are incident under a condition where they partially overlap with each other in the predetermined plane P1. This can substantially narrow the intervals between the image light rays L2 and thus it is possible to improve the filling factor of the pupil of the image light ray L1 in the field of view region Ac and thereby the image quality can be improved.

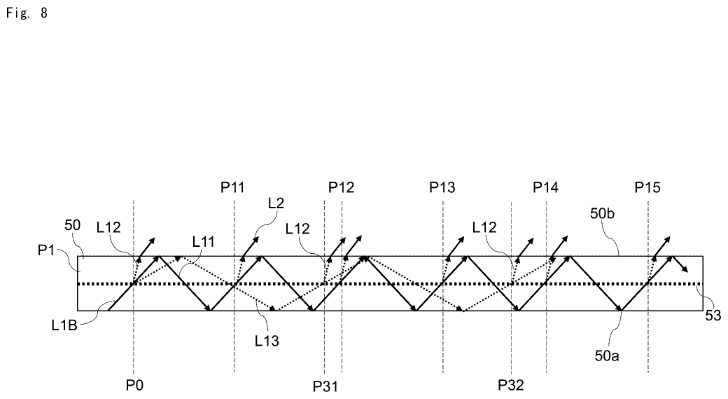

FIG. 8 is an explanatory view of one example of diffraction of an image light ray by the exit extension region 53 of the light guide 5 of FIG. 3. In the present embodiment, the exit extension region 53 divides at least the image light ray L1B first incident on the exit extension region 53 from the incident region 51, into the first image light ray L11, the second image light ray L12, and the third image light ray L13 (see the position P0). The exit extension region 53 divides the first image light ray L11 which has reciprocated at an arbitrary number of times inside the exit extension region 53, into the first image light ray L11, the second image light ray L12, and the third image light ray L13 (see the positions P11, P12, P13, P14, P15). The number of times of reciprocation m₁ of the first image light ray L11 at the positions P11, P12, P13, P14, and P15 are 1, 2, 3, 4, and 5, respectively. The exit extension region 53 divides the third image light ray L13 which has reciprocated at an arbitrary number of times inside the exit extension region 53, into the first image light ray L11, the second image light ray L12, and the third image light ray L13 (see the positions P31, P32). The number of times of reciprocation m₂ of the third image light ray L13 at the positions P31 and P32 are 1 and 2, respectively. The number of times of reciprocation means the number of times that the first image light ray or the third image light ray emerges from the exit extension region 53 and is reflected by the first surface 50a and the second surface 50b of the body 50 and thereafter returns to the exit extension region 53. Accordingly, when the image light ray L1B is incident on the exit extension region 53 at the position P0, the number of times of reciprocation of the first image light ray is 1, 2, 3, . . . at the positions P11, P12, P13, . . . and the number of times of reciprocation of the third image light ray is 1, 2, . . . at the positions P31, P32, . . . .

The aforementioned light guide 5 is configured to satisfy or fulfill the following formulae (1), (2), and (3).

$$\begin{matrix}[ FORMULA 1 ] & \\ \frac{\frac{1}{n} sin {θ}_{o} + 1}{2} > sin {θ}_{i} > \frac{1}{n} & ( 1 )\end{matrix}$$

$$\begin{matrix}[ FORMULA 2 ] & \\ \vert {m}_{1} \times \frac{2 T}{cos {θ}_{i}} - {m}_{2} \times \frac{2 T}{cos {θ}_{p}} \vert > \frac{{( λ / n )}^{2}}{Δλ / n} & ( 2 )\end{matrix}$$

$$\begin{matrix}[ FORMULA 3 ] & \\ \vert \frac{λ}{n} \times \frac{1}{sin ( {θ}_{i} - {θ}_{f 2} ) - sin ( {θ}_{i} + {θ}_{f 1} )} \vert > d > \vert \frac{λ}{n} \times \frac{1}{sin {θ}_{i} - 1} \vert & ( 3 )\end{matrix}$$

With regard to the formula (1), θᵢ is a propagation angle [°]. θₒ is an angle [°] at which the second image light ray L12 emerges from the body 50. n is a refractive index of the body 50.

With regard to the formula (2), Op is the third angle [°]. T is a thickness [μm] of the body 50. m₁ is a number of times of reciprocation of the first image light ray L11 inside the exit extension region 53 when incident on the overlap part 53a. m₂ is a number of times of reciprocation of the third image light ray L13 inside the exit extension region 53 when incident on the overlap part 53a. m₁ and m₂ each are positive integers.

With regard to the formula (3), θ_{i 0} is a propagation angle [°] of a central light beam of a picture (the virtual image Iv) visually perceived by an observer (the user D). Thus, θ_{i 0} is a propagation angle of a central light beam of the image light ray L1. θ_{f 1} and θ_{f 2} each are positive values [°]. In particular, θ_{f 1} is a value [°] which defines an upper limit of a range of the propagation angle θᵢ and the upper limit of the range of the propagation angle θᵢ is represented by θ_{i 0}+θ_{f 1}. θ_{f 2} is a value [°] which defines a lower limit of the range of the propagation angle θᵢ and the lower limit of the range of the propagation angle θᵢ is represented by θ_{i 0}−θ_{f 2}. Consequently, the range of the propagation angle θᵢ is equal to or greater than θ_{i 0}−θ_{f 2} and is equal to or smaller than θ_{i 0}+θ_{f 1}. d is the diffraction pitch [μm] of the diffraction structure of the exit extension region 53.

First of all, referring to FIG. 5, the formula (1) is described. By the light guide 5 satisfying the above formula (1), the exit extension region 53 can divide the image light ray L1B which propagates in the first propagation direction and is incident on the exit extension region 53, into the first image light ray L11, the second image light ray L12, and the third image light ray L13, in the predetermined plane P1 including the first propagation direction and the second propagation direction. The first image light ray L11 and the third image light ray L13 may propagate in the first propagation direction inside the body 50 and the second image light ray L12 may emerge outside from the body 50.

The first angle θ_{o 1} of the first image light ray L11 satisfies the condition of propagation inside the body 50 by total reflection. As described above, the first image light ray L11 corresponds to a zero-order diffraction light relative to the image light ray L1B. Accordingly, the first angle θ_{o 1} is equal to the propagation angle θᵢ of the image light ray L1 propagating from the incident region 51 to the exit extension region 53 in the predetermined plane P1. Therefore, from the conditions for the total reflection of Snell's law, the propagation angle θᵢ is set to satisfy the following formula (4).

$$\begin{matrix}[ FORMULA 4 ] & \\ sin {θ}_{i} > \frac{1}{n} & ( 4 )\end{matrix}$$

As described above, the second image light ray L12 corresponds to a first positive order diffraction light relative to the image light ray L1B and the third image light ray L13 corresponds to a first negative order diffraction light relative to the image light ray L1B. Diffraction caused by the exit extension region 53 may be represented by the following formula (5).

$$\begin{matrix}[ FORMULA 5 ] & \\ n\_out \times sin {θ}_{m} - n\_in \times sin {θ}_{i} = \frac{m \times λ}{d} & ( 5 )\end{matrix}$$

In the formula (5), m represents a diffraction order. Om is an exit angle of an image light ray emerging from the exit extension region 53 in the predetermined plane P1. n_in is a refractive index of a medium on an incident side relative to the exit extension region 53. n_out is a refractive index of a medium on an exit side relative to the exit extension region 53. In the present embodiment, the medium on the incident side relative to the exit extension region 53 and the medium on the exit side relative to the exit extension region 53 each are the body 50 of the light guide 5. Therefore, n_in and n_out are equal to the refractive index n of the body 50. Accordingly, from the above formula (5), the following formula (6) can be obtained.

$$\begin{matrix}[ FORMULA 6 ] & \\ sin {θ}_{m} - sin {θ}_{i} = \frac{m \times λ}{n \times d} & ( 6 )\end{matrix}$$

The second image light ray L12 is a first positive diffraction light relative to the image light ray L1B and in the second image light ray L12, m=1. Additionally, regarding the second image light ray L12, the exit angle θₘ is equal to the second angle θ_{o 2}. Therefore, for the second image light ray L12, the following formula (7) is established.

$$\begin{matrix}[ FORMULA 7 ] & \\ sin {θ}_{o 2} - sin {θ}_{i} = \frac{λ}{n \times d} & ( 7 )\end{matrix}$$

The third image light ray L13 is a first negative diffraction light relative to the image light ray L1B and in the third image light ray L13, m=−1. Additionally, regarding the third image light ray L13, the exit angle θₘ is equal to the third angle θₚ. Therefore, for the third image light ray L13, the following formula (8) is established.

$$\begin{matrix}[ FORMULA 8 ] & \\ sin {θ}_{p} - sin {θ}_{i} = \frac{- λ}{n \times d} & ( 8 )\end{matrix}$$

The condition for existence of the third image light ray L13 is equivalent to a condition for existence of θₚ. From the above, the condition for existence of the third image light ray L13 is given by the following formula (9).

$$\begin{matrix}[ FORMULA 9 ] & \\ sin {θ}_{p} < 1 & ( 9 )\end{matrix}$$

From the formula (8) and the formula (9), the following formula (10) is obtained.

$$\begin{matrix}[ FORMULA 10 ] & \\ sin {θ}_{i} - \frac{λ}{n \times d} < 1 & ( 10 )\end{matrix}$$

From the formula (7) and the formula (10), the following formula (11) is obtained.

$$\begin{matrix}[ FORMULA 11 ] & \\ sin {θ}_{i} - ( sin {θ}_{02} - sin {θ}_{i} ) < 1 & ( 11 )\end{matrix}$$

For a relation between the second angle θ_{o 2} at which the second image light ray L12 emerges from the exit extension region 53 and an angle θₒ at which the second image light ray L12 emerges from the body 50, the following formula (12) is established.

$$\begin{matrix}[ FORMULA 12 ] & \\ sin {θ}_{02} = \frac{1}{n} sin {θ}_{o} & ( 12 )\end{matrix}$$

From the formula (11) and the formula (12), the following formula (13) is obtained.

$$\begin{matrix}[ FORMULA 13 ] & \\ \frac{\frac{1}{n} sin {θ}_{o} + 1}{2} > sin {θ}_{i} & ( 13 )\end{matrix}$$

From the formula (4) and the formula (13), the above formula (1) is obtained.

Next, with reference to FIG. 6 and FIG. 8, the formula (2) will be explained. The formula (2) represents a condition that the difference between the optical paths of the first image light ray L11 and the third image light ray L13 which are incident on the overlap part 53a is longer than the coherence length of the image light ray L1. Accordingly, by satisfying the formula (2), interference between the image light rays L2b and L2c is reduced and a decrease in the image quality of the virtual image Iv can be reduced.

The right side of the formula (2) represents the coherence length of the image light ray L1 as described with reference to FIG. 6 above.

The optical path of the first image light ray L11 incident on the overlap part 53a is represented by the following formula (14).

$$\begin{matrix}[ FORMULA 14 ] & \\ {m}_{1} \times \frac{2 T}{cos {θ}_{i}} & ( 14 )\end{matrix}$$

The optical path of the third image light ray L13 incident on the overlap part 53a is represented by the following formula (15).

$$\begin{matrix}[ FORMULA 15 ] & \\ {m}_{2} \times \frac{2 T}{cos {θ}_{p}} & ( 15 )\end{matrix}$$

Thus, the condition that the difference between the optical paths of the first image light ray L11 and the third image light ray L13 which are incident on the overlap part 53a is longer than the coherence length of the image light ray L1 is given by the above formula (2).

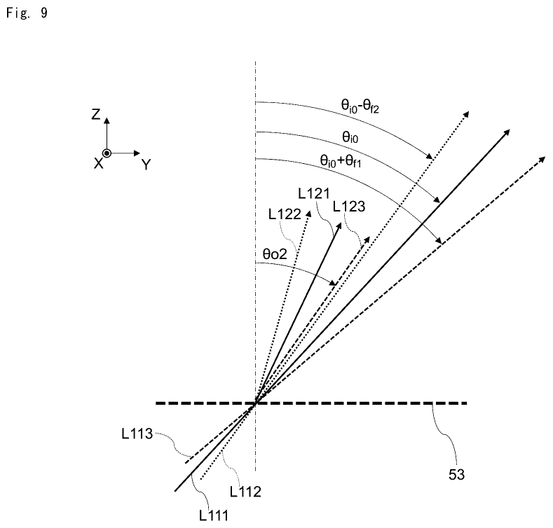

Next, with reference to FIG. 9, the formula (3) will be explained. For the formula (3), the range of the propagation angle θᵢ is assumed to be equal to or greater than θ_{i 0}−θ_{f 2} and be equal to or smaller than θ_{i 0}+θ_{f 1}. As one example, in the present embodiment, θ_{i 0} is the propagation angle of the central light beam of the image light ray L1 and θ_{f 1} and θ_{f 2} are positive values. In particular, θ_{i 0}−θ_{f 2} is a propagation angle of a light beam corresponding to an upper side of an angle of view of the image light ray L1, which means an upper end of the field of view region Ac. As one example, in the present embodiment, θ_{i 0}+θ_{f 1} is a propagation angle of a light beam corresponding to a lower side of the angle of view of the image light ray L1, which means a lower end of the field of view region Ac.

In FIG. 9, the image light ray L111 is an image light ray with the propagation angle θ_{i 0}, the image light ray L112 is an image light ray with the propagation angle θ_{i 0}−θ_{f 2}, and the image light ray L113 is an image light ray with the propagation angle θ_{i 0}+θ_{f 1}. In FIG. 9, the image light ray L121 is the second image light ray for the image light ray L111, the image light ray L122 is the second image light ray for the image light ray L112, and the image light ray L123 is the second image light ray for the image light ray L113.

In FIG. 9, when the image light ray L112 and the image light ray L123 overlap with each other, the image light ray L112 does not propagate inside the body 50 in the first propagation direction and is extracted outside from the body 50, or the image light ray L123 is not extracted outside from the body 50 but propagates inside the body 50 in the first propagation direction. Therefore, in the range of the propagation angle θᵢ, the image light ray L1 does not propagate properly, and a predetermined angle of view of the image light ray L1 is not maintained and this may cause a decrease in the image quality of the virtual image Iv.

As understood from FIG. 9, a condition that a second image light ray L12 with one propagation angle θᵢ and a second image light ray L12 with another propagation angle θᵢ does not overlap with each other is that the second angle θ_{o 2} of the image light ray L123 is smaller than the propagation angle θ_{i 0}−θ_{f 2} of the image light ray L112.

Herein, only for convenience, to make the diffraction pitch a positive value, the following formula (16) is used as an alternative to the above formula (6).

$$\begin{matrix}[ FORMULA 16 ] & \\ sin {θ}_{m} - sin {θ}_{i} = - \frac{m \times λ}{n \times d} & ( 16 )\end{matrix}$$

From the above formula (16), the second angle θ_{o 2} of the image light ray L123 is represented by the following formula (17).

$$\begin{matrix}[ FORMULA 17 ] & \\ sin {θ}_{o 2} = sin ( {θ}_{i 0} + {θ}_{f 1} ) - \frac{λ}{n \times d} & ( 17 )\end{matrix}$$

When the second angle θ_{o 2} of the image light ray L123 is smaller than the propagation angle θ_{i 0}−θ_{f 2} of the image light ray L112, the following formula (18) is established.

$$\begin{matrix}[ FORMULA 18 ] & \\ sin {θ}_{o 2} < sin ( {θ}_{i 0} - {θ}_{f 2} ) & ( 18 )\end{matrix}$$

From the formula (17) and the formula (18), the following formula (19) is obtained.

$$\begin{matrix}[ FORMULA 19 ] & \\ sin ( {θ}_{i 0} + {θ}_{f 1} ) - \frac{λ}{n \times d} < sin ( {θ}_{i 0} - {θ}_{f 2} ) & ( 19 )\end{matrix}$$

By simplifying the formula (19) for the diffraction pitch d, the following formula (20) is obtained.

$$\begin{matrix}[ FORMULA 20 ] & \\ d < \frac{λ}{n} \times \frac{1}{sin ( {θ}_{i 0} + {θ}_{f 1} ) - sin ( {θ}_{i 0} - {θ}_{f 2} )} & ( 20 )\end{matrix}$$

From the formula (16), the condition for the existence of a first negative order diffraction light when the propagation angle θᵢ is equal to the propagation angle θ_{i 0} of the central light beam of the image light ray L1 is represented by the following formula (21).

$$\begin{matrix}[ FORMULA 21 ] & \\ sin {θ}_{i 0} + \frac{λ}{n \times d} < 1 & ( 21 )\end{matrix}$$

By simplifying the formula (21) for the diffraction pitch d, the following formula (22) is obtained.

$$\begin{matrix}[ FORMULA 22 ] & \\ d > \frac{λ}{n} \times \frac{1}{1 - sin {θ}_{i 0}} & ( 22 )\end{matrix}$$

From the formula (20) and the formula (22), the above formula (3) is obtained.

As described above, in the light guide 5, the exit extension region 53 includes the overlap part 53a on which the first image light ray L11 and the third image light ray L13 are incident under the condition where they partially overlap with each other in the predetermined plane P1. Therefore, the intervals or gaps between the image light rays L2 are decreased and it enables improvement of the filling factor of the pupil of the image light ray L1 in the field of view region Ac.

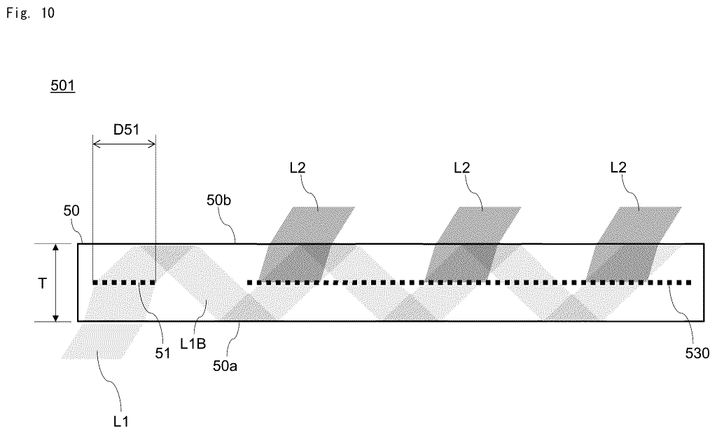

Hereinafter, referring to reference examples 1 to 4 of FIG. 10 to FIG. 13, an explanation is made to conventional measures for improving the filling factor of the pupil of the image light ray L1 in the field of view region Ac. Note that, in reference examples 1 to 4, reference example 1 indicates an example where the filling factor of the pupil of the image light ray L1 is low due to not taking measure for improving the filling factor of the pupil of the image light ray L1.

FIG. 10 is an explanatory view of one example of diffraction of an image light ray by a light guide 501 of reference example 1. The light guide 501 of FIG. 10 includes the body 50, the incident region 51, the auxiliary extension region 52 and an exit extension region 530. Note that, in FIG. 10, to simplify the drawing, the auxiliary extension region 52 is not depicted. The exit extension region 530 of FIG. 10 is configured to divide the image light ray L1B propagating in the first propagation direction into a plurality of the image light ray L2 which propagate in the second propagation direction and emerge from the second surface 50b of the body 50 in the second inclined direction, in the first propagation direction. In FIG. 10, there are gaps between the image light rays L2 and the filling factor of the pupil of the image light ray L1 is low.

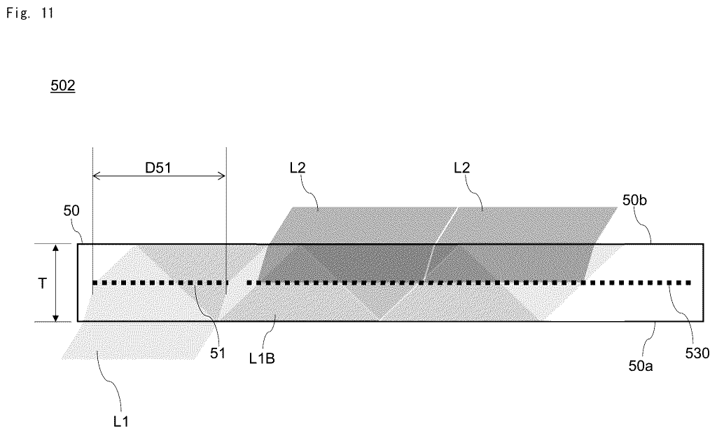

FIG. 11 is an explanatory view of one example of diffraction of an image light ray by a light guide 502 of reference example 2. The light guide 502 of FIG. 11 has a size larger than the size of the light guide 501 of FIG. 10. In detail, in the incident region 51 of FIG. 11, a dimension D51 of the incident region 51 in the first propagation direction is larger than that of the incident region 51 of FIG. 10. This can enlarge the pupil itself of the image light ray L1. Therefore, the light guide 502 of FIG. 11 can narrow intervals between the image light rays L2 relative to the light guide 501 of FIG. 10 and enables improvement of the filling factor of the pupil of the image light ray L1. However, when the size of the incident region 51 is increased like FIG. 11, it is necessary to ensure a space for the incident region 51 and this therefore leads to necessity of an increase in the size of the body 50. Further, it is necessary to output a wide image light ray, and this may result in an increase in a size of the display element 2. As a result, a size of the optical system 3, and additionally a size itself of the image display device 1 becomes larger, and a layout of the image display device 1 may be limited.

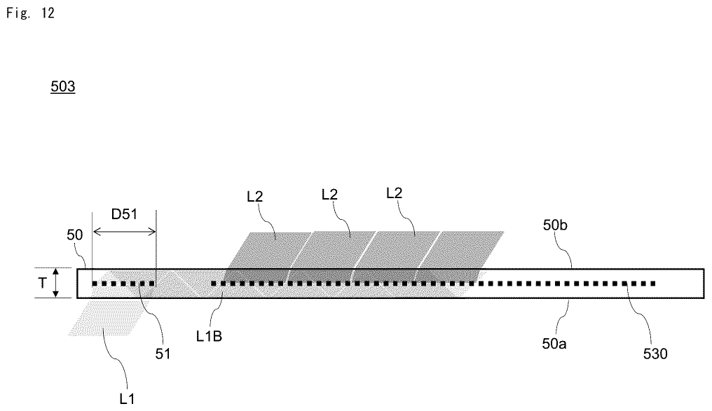

FIG. 12 is an explanatory view of one example of diffraction of an image light ray by a light guide 503 of reference example 3. The light guide 503 of FIG. 12 has a thickness T of the body 50 smaller than that of the light guide 501 of FIG. 10. This can shorten a distance of reciprocation of the image light ray L1B between the first surface 50a and the second surface 50b of the body 50, and this can shorten intervals between points where the image light ray L1B is extracted from the body 50 in the first propagation direction. Therefore, the light guide 503 of FIG. 12 can narrow intervals between the image light rays L2 relative to the light guide 501 of FIG. 10 and enables improvement of the filling factor of the pupil of the image light ray L1. However, making the thickness T of the body 50 smaller like FIG. 12 may cause various problems such as an increase in difficulty in processing materials of the light guide 503, a decrease in a strength of the light guide 503, and an increase in a degree of influence on vibration of the light guide 503.

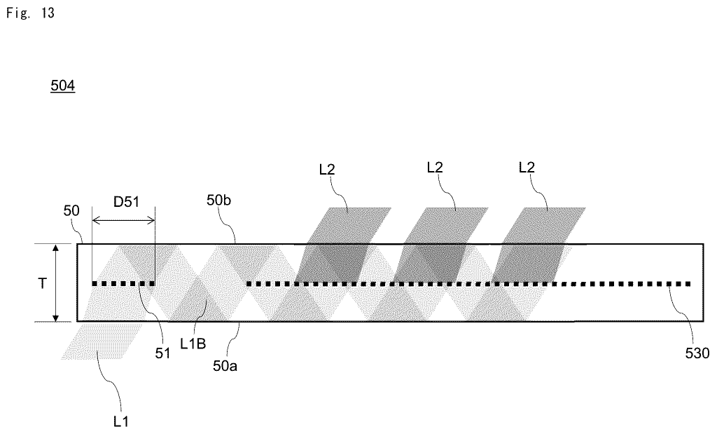

FIG. 13 is an explanatory view of one example of diffraction of an image light ray by a light guide 504 of reference example 4. The light guide 504 of FIG. 13 has a refractive index n of the body 50 higher than that of the light guide 501 of FIG. 10. This can decrease the propagation angle of the image light ray L1B, and this can shorten intervals between points where the image light ray L1B is extracted from the body 50 in the first propagation direction. Therefore, the light guide 504 of FIG. 13 can narrow intervals between the image light rays L2 relative to the light guide 501 of FIG. 10 and enables improvement of the filling factor of the pupil of the image light ray L1. However, materials available for the body 50 are limited, and there may be a limit for improvement of the filling factor by a refractive index.

In the present embodiment, the light guide 5 can narrow the intervals between the image light rays L2 and can reduce an area where no pupil of the image light ray L1 is located in the field of view region Ac, without adopting conventional measures such as a change in the size of the incident region 51, a change in the thickness T of the body 50 of the light guide 5, and a change in the refractive index n of the body 50 of the light guide 5. Especially, an increase in the size of the incident region 51 may result in an increase in the sizes of the optical system 3 and the image display device 1. In the light guide 5, there is no need to increase the size of the incident region 51 to reduce absence of the pupil of the image light ray L1 in the field of view region Ac and thus it is possible to downsize the incident region 51. Additionally, in the overlap part 53a, the image light rays L2b and L2c partially overlap with each other. However, since the difference between the optical paths of the first image light ray L11 and the third image light ray L13 incident on the overlap part 53a is longer than the coherence length of the image light ray L1, there may be no interference between the image light rays L2b and L2c and this can reduce a decrease in the image quality of the virtual image Iv.

The projection optical system 6 projects the image light ray L1 which is output from the display element 2 and forms the image. Thus, the projection optical system 6 allows the image light ray L1 from the display element 2 to be incident on the light guide 5. As shown in FIG. 1, the projection optical system 6 is positioned between the display element 2 and the light guide 5. The projection optical system 6 collimates the image light ray L1 from the display element 2 and allows it to be incident on the incident region 51, for example. The projection optical system 6 allows the image light ray L1 to be incident on the incident region 51 as a substantial collimated light ray. The projection optical system 6 may be a biconvex lens, for example.

As described above, the image light ray L1 in fact may be incident on the optical system 3 as a light ray with an angle corresponding to a field of view angle. In FIG. 3, an irradiated region A10 of the image light ray L1 in the incident region 51 has a first dimension a1 and a second dimension a2. The first dimension a1 is a dimension of the irradiated region A10 in the first propagation direction (the positive direction of the Y axis). The second dimension a2 is a dimension of the irradiated region A10 in a direction perpendicular to each of the thickness direction of the body 50 and the first propagation direction (a direction of the X axis). In the present embodiment, the first dimension a1 is smaller than the second dimension a2. This means that the image light ray L1 has an angle of view which is smaller in a direction (e.g., the vertical direction of the field of view region Ac) corresponding to the first propagation direction than in a direction (e.g., the horizontal direction of the field of view region Ac) corresponding to a direction (the direction of the X axis) perpendicular to each of the thickness direction of the body 50 and the first propagation direction. This can make a distance between the pupils of the image light ray L1 in the first propagation direction smaller than in a case where the first dimension a1 is greater or larger than the second dimension a2. Accordingly, it is possible to reduce absence of the pupil of the image light ray L1 in the field of view region Ac and additionally to downsize the incident region 51. In FIG. 3, the irradiated region A10 has an ellipse shape, the first dimension a1 corresponds to a minor axis, and the second dimension a2 corresponds to a major axis. The irradiated region A10 may not be limited to an ellipse shape but may be a rectangular shape with the first dimension being shorter than the second dimension a2.

The control device 4 can be realized by semiconductor elements or the like. The control device 4 may be configured by a microcomputer, a CPU, an MPU, a GPU, a DSP, a FPGA, or an ASIC, for example. The control device 4 realizes a predetermined function by performing various arithmetic processing by reading out data or programs stored in a storage device 4a. The storage device 4a is a storage medium for storing programs or data necessary for realizing the function of the control device 4. The storage device 4a may be realized by a hard disc drive (HDD), an SSD, an RAM, a DRAM, a ferroelectric memory, a flash memory, a magnetic disk, or a combination thereof, for example. The storage device 4a stores a plurality of files of image data representing the virtual image Iv as an optical image. The control device 4 determines the virtual image Iv to be displayed, based on a vehicle relation information obtained from the outside. The control device 4 reads out the image data of the determined virtual image Iv from the storage device 4a and outputs it to the display element 2.

### 1.2 Working Examples and Comparative Examples

Hereinafter, working examples and comparative examples of the light guide 5 will be described. The following working examples are just some of possible working examples of the light guide 5.

Following TABLE 1 shows parameters of working examples 1 to 6. Following TABLE 2 shows parameters of comparative examples 1 to 6. The parameters of TABLE 1 and TABLE 2 include the incident angle (propagation angle) θᵢ [°], an extracted angle (the angle at which the second image light ray L12 emerges from the body 50) θₒ [°], a first negative order propagation angle (the third angle) θₚ [°], the diffraction pitch d [μm] of the diffraction structure of the exit extension region 53, the thickness T [μm] of the light guide 5 (the thickness of the body 50), the refractive index n of the light guide 5 (the refractive index of the body 50), the central wavelength λ [μm] of the image light ray L1, the line width Δλ [μm] of the image light ray L1, the number of times of reciprocation m₁ of the first image light ray L11 inside the exit extension region 53 when incident on the overlap part 53a, and the number of times of reciprocation m₂ of the third image light ray L13 inside the exit extension region 53 when incident on the overlap part 53a.

TABLE 1

| | θᵢ | θₒ | θₚ | d | T | n | λ | Δλ | m₁ | m₂ |
|---|---|---|---|---|---|---|---|---|---|---|
| WORKING | 45.00 | 55.31 | 60.00 | 2.181 | 1000 | 1.5 | 0.52 | 0.0030 | 2 | 1 |
| EXAMPLE 1 | | | | | | | | | | |
| WORKING | 45.00 | 55.31 | 60.00 | 2.181 | 2000 | 1.5 | 0.52 | 0.0001 | 2 | 1 |
| EXAMPLE 2 | | | | | | | | | | |
| WORKING | 45.00 | 80.63 | 60.00 | 1.817 | 100 | 1.8 | 0.52 | 0.0010 | 2 | 1 |
| EXAMPLE 3 | | | | | | | | | | |
| WORKING | 50.00 | 69.83 | 65.00 | 2.471 | 200 | 1.5 | 0.66 | 0.0010 | 2 | 1 |
| EXAMPLE 4 | | | | | | | | | | |
| WORKING | 45.00 | 45.38 | 70.00 | 1.490 | 1000 | 1.5 | 0.52 | 0.0005 | 3 | 1 |
| EXAMPLE 5 | | | | | | | | | | |
| WORKING | 45.00 | 63.21 | 55.00 | 3.094 | 1000 | 1.5 | 0.52 | 0.0010 | 2 | 2 |
| EXAMPLE 6 | | | | | | | | | | |

TABLE 2

| | θᵢ | θₒ | θₚ | D | T | n | λ | Δλ | m₁ | m₂ |
|---|---|---|---|---|---|---|---|---|---|---|
| COMPARATIVE | 45.00 | 55.31 | 60.00 | 2.181 | 1000 | 1.5 | 0.52 | 0.0001 | 2 | 1 |
| EXAMPLE 1 | | | | | | | | | | |
| COMPARATIVE | 45.00 | 55.31 | 60.00 | 2.181 | 500 | 1.5 | 0.52 | 0.0001 | 2 | 1 |
| EXAMPLE 2 | | | | | | | | | | |
| COMPARATIVE | 45.00 | 80.63 | 60.00 | 2.337 | 100 | 1.4 | 0.52 | 0.0010 | 2 | 1 |
| EXAMPLE 3 | | | | | | | | | | |
| COMPARATIVE | 50.00 | 69.83 | 65.00 | 2.471 | 200 | 1.5 | 0.75 | 0.0010 | 2 | 1 |
| EXAMPLE 4 | | | | | | | | | | |
| COMPARATIVE | 45.00 | 45.38 | 70.00 | 1.490 | 1000 | 1.5 | 0.52 | 0.0005 | 2 | 1 |
| EXAMPLE 5 | | | | | | | | | | |
| COMPARATIVE | 45.00 | 63.21 | 55.00 | 3.094 | 100 | 1.5 | 0.52 | 0.0010 | 2 | 2 |
| EXAMPLE 6 | | | | | | | | | | |

Following TABLE 3 indicates the coherence lengths Lc [μm] of the image light ray L1 and the differences Ld between the optical paths of the first image light ray L11 and the third image light ray L13 incident on the overlap part 53a in working examples 1 to 6. Following TABLE 4 indicates the coherence lengths Lc [μm] of the image light ray L1 and the differences Ld between the optical paths of the first image light ray L11 and the third image light ray L13 incident on the overlap part 53a in comparative examples 1 to 6.

TABLE 3

| | Lc | Ld |
|---|---|---|
| WORKING EXAMPLE 1 | 60.089 | 1656.854 |
| WORKING EXAMPLE 2 | 1802.667 | 3313.708 |
| WORKING EXAMPLE 3 | 150.222 | 165.685 |
| WORKING EXAMPLE 4 | 290.400 | 298.098 |
| WORKING EXAMPLE 5 | 360.533 | 2637.673 |
| WORKING EXAMPLE 6 | 180.267 | 1316.933 |

TABLE 4

| | Lc | Ld |
|---|---|---|
| COMPARATIVE EXAMPLE 1 | 1802.667 | 1656.854 |
| COMPARATIVE EXAMPLE 2 | 1802.667 | 828.427 |
| COMPARATIVE EXAMPLE 3 | 193.143 | 165.685 |
| COMPARATIVE EXAMPLE 4 | 375.000 | 298.098 |
| COMPARATIVE EXAMPLE 5 | 360.533 | 190.755 |
| COMPARATIVE EXAMPLE 6 | 180.267 | 131.693 |

As described above, from TABLE 3, working examples 1 to 6 satisfy or fulfill the formula (2). In contrast, from TABLE 4, comparative examples 1 to 6 do not satisfy the formula (2). Therefore, comparative examples 1 to 6 may decrease in the image quality of the virtual image Iv in comparison with working examples 1 to 6.

By comparing working example 1 with comparative example 1, the line width Δλ is changed from 0.0001 [μm] of comparative example 1 to 0.003 [μm] of working example 1. As one example, a light source used in the display element 2 is changed from a 0.1 nm single-mode laser to a 3.0 nm multi-mode laser. By comparing working example 2 with comparative example 2, the thickness T is changed from 500 [μm] of comparative example 2 to 1000 [μm] of working example 2. By comparing working example 3 with comparative example 3, the diffraction pitch d is changed from 2.337 [μm] of comparative example 3 to 1.817 [μm] of working example 3, and the refractive index is changed from 1.4 of comparative example 3 to 1.8 of working example 3. Working example 3 can satisfy the formula (2) while keeping the propagation angle θᵢ. By comparing working example 4 with comparative example 4, the central wavelength λ is changed from 0.75 [μm] of comparative example 4 to 0.66 [μm] of working example 4. In working example 4, although the color of the image light ray L1 is changed, it is possible to reduce a decrease in the image quality due to interference. By comparing working example 5 with comparative example 5, the number of times of reciprocation m₁ is changed from 2 of comparative example 5 to 3 of working example. In working example 5, the formula (2) is satisfied by adjusting the number of times of reciprocation of the first image light ray L11 at the overlap part 53a and it is possible to reduce a decrease in the image quality due to interference. By comparing working example 6 with comparative example 6, the thickness T is changed from 100 [μm] of comparative example 6 to 1000 [μm] of working example 6. In working example 6, the thickness T can be ten times as large as in comparative example 6. Therefore, it is possible to solve the various problems such as an increase in difficulty in processing materials of the light guide 5, a decrease in a strength of the light guide 5, and an increase in a degree of influence on vibration of the light guide 5.

### 1.3 Advantageous Effects

The aforementioned optical system 3 includes the light guide 5 for guiding the image light ray L1 which is output from the display element 2 and forms an image, to the field of view region Ac of the user D as the optical image (the virtual image Iv). The light guide 5 includes: the body 50 having a plate shape; the incident region 51 formed at the body 50 and allowing the image light ray L1 to enter the body 50 so that the image light ray L1 propagates inside the body 50; and the exit extension region 53 formed at the body 50 and including the diffraction structure dividing the image light ray L1B propagating in the first propagation direction intersecting the thickness direction of the body 50, into a plurality of image light rays L2 propagating in the second propagation direction intersecting the first propagation direction, in the first propagation direction, and allowing them to emerge from the body 50. The exit extension region 53 divides the image light ray L1B, L11, L13 which propagates in the first propagation direction and is incident on the exit extension region 53, into the first image light ray L11, the second image light ray L12, and the third image light ray L13, in the predetermined plane P1 including the first propagation direction and the second propagation direction. The first image light ray L11 emerges from the exit extension region 53 at the first angle equal to the propagation angle of the image light ray L1B propagating from the incident region 51 to the exit extension region 53 in the predetermined plane P1 to propagate inside the body 50. The second image light ray L12 emerges from the exit extension region 53 at the second angle different from the first angle to emerge from the body 50. The third image light ray L13 emerges from the exit extension region 53 at the third angle different from the first angle and the second angle to propagate inside the body 50. The exit extension region 53 includes the overlap part 53a on which the first image light ray L11 and the third image light ray L13 are incident under a condition where they partially overlap with each other in the predetermined plane P1. The difference between the optical paths of the first image light ray L11 and the third image light ray L13 incident on the overlap part 53a is longer than the coherence length of the image light ray L1. This configuration can improve the filling factor of the pupil of the image light ray L1 in the field of view region Ac and decrease the size of the incident region 51.

In the optical system 3, the formulae (1) and (2) are satisfied.

$$\begin{matrix}[ FORMULA 23 ] & \\ \frac{\frac{1}{n} sin {θ}_{o} + 1}{2} > sin {θ}_{i} > \frac{1}{n} & ( 1 )\end{matrix}$$

$$\begin{matrix}[ FORMULA 24 ] & \\ \vert {m}_{1} \times \frac{2 T}{cos {θ}_{i}} - {m}_{2} \times \frac{2 T}{cos {θ}_{p}} \vert > \frac{{( λ / n )}^{2}}{Δλ / n} & ( 2 )\end{matrix}$$

θᵢ is the propagation angle [°], θₒ is the angle [°] at which the second image light ray L12 emerges from the body 50, θₚ is the third angle, n is the refractive index of the body 50, Tis the thickness [μm] of the body 50, m₁ is the number of times of reciprocation of the first image light ray L11 inside the exit extension region 53 when incident on the overlap part 53a, m₂ is the number of times of reciprocation of the third image light ray L13 inside the exit extension region 53 when incident on the overlap part 53a, A is the central wavelength [μm] of the image light ray L1, and Ax is the line width [μm] of the image light ray L1. This configuration can reduce absence of the pupil of the image light ray L1 in the field of view region Ac and decrease the size of the incident region 51.

In the optical system 3, when the range of the propagation angle is equal to or greater than θ_{i 0}−θ_{f 2} and is equal to or smaller than θ_{i 0}+θ_{f 1}, the formula (3) is satisfied.

$$\begin{matrix}[ FORMULA 25 ] & \\ \vert \frac{λ}{n} \times \frac{1}{sin ( {θ}_{i 0} - {θ}_{f 2} ) - sin ( {θ}_{i 0} + {θ}_{f 1} )} \vert > d > \vert \frac{λ}{n} \times \frac{1}{sin {θ}_{i 0} - 1} \vert & ( 3 )\end{matrix}$$

d is the diffraction pitch [μm] of the diffraction structure of the exit extension region 53, n is the refractive index of the body 50, λ is the central wavelength [μm] of the image light ray L1, θ_{i o} is the propagation angle [°] of the central light beam of the image light ray L1, and θ_{f 1} and θ_{f 2} are positive values [°]. This configuration can reduce absence of the pupil of the image light ray L1 in the field of view region Ac and decrease the size of the incident region 51.

In the optical system 3, part of the exit extension region 53 which divides the image light ray L1B into the first image light ray L11, the second image light ray L12 and the third image light ray L13 is at least included in the end on the side of the incident region 51, of the exit extension region 53 in the optical path of the image light ray L1 from the incident region 51 to the exit extension region 53. This configuration can reduce absence of the pupil of the image light ray L1 in the field of view region Ac and decrease the size of the incident region 51.

In the optical system 3, the exit extension region 53 divides the third image light ray L13 which has reciprocated at an arbitrary number of times inside the exit extension region 53, into the first image light ray L11, the second image light ray L12, and the third image light ray L13. This configuration can reduce absence of the pupil of the image light ray L1 in the field of view region Ac and decrease the size of the incident region 51.

In the optical system 3, the irradiated region A10 of the image light ray L1 in the incident region 51 has the first dimension a1 in the first propagation direction and the second dimension a2 in the direction perpendicular to each of the thickness direction of the body 50 and the first propagation direction, and the first dimension a1 is smaller than the second dimension a2. This configuration can reduce absence of the pupil of the image light ray L1 in the field of view region Ac and decrease the size of the incident region 51.

In the optical system 3, the light guide 5 further includes the auxiliary extension region 52 which is formed at the body 50 and includes the diffraction structure dividing the image light ray L1A propagating in the predetermined direction inside the body 50 by the incident region 51, into a plurality of image light rays L1B propagating in the first propagation direction, in the predetermined direction, and allowing them to travel toward the exit extension region 53. This configuration allows expansion of the pupil in a plurality of different directions.

In the optical system 3, the predetermined direction corresponds to the horizontal direction of the field of view region Ac, and the first propagation direction corresponds to the vertical direction of the field of view region Ac. This configuration enables the pupil expansion in the horizontal direction and the vertical direction, of the field of view region Ac.

In the optical system 3, the light guide 5 is positioned to guide the image light ray L2 emerging from the body 50 to the field of view region Ac as the optical image (the virtual image Iv) by reflecting the image light ray L2 by the light-transmissive member (the windshield 101). This configuration allows application to head-up displays.

In the optical system 3, the body 50 includes the first surface 50a and the second surface 50b in the thickness direction. The incident region 51 allows the image light ray L1 incident on the first surface 50a in the first inclined direction inclined relative to the normal line of the first surface 50a, to enter the body 50 so that the image light ray L1 propagates inside the body 50. The exit extension region 53 allows the plurality of image light rays L1C propagating in the second propagation direction to emerge from the second surface 50b in the second inclined direction inclined relative to the normal line of the second surface 50b. This configuration can reduce absence of the pupil of the image light ray L1 in the field of view region Ac and decrease the size of the incident region 51.

In the optical system 3, the first inclined direction and the second inclined direction are parallel to each other. This configuration can reduce absence of the pupil of the image light ray L1 in the field of view region Ac and decrease the size of the incident region 51.

In the optical system 3, the diffraction structure of the exit extension region 53 is a volume holographic element positioned inside the body 50 This configuration can easily increase a size of the exit expansion region 53.

The optical system 3 further includes the projection optical system 6 allowing the image light ray L1 to be incident on the incident region 51 of the light guide 5 as a substantial collimate light ray. This configuration can further improve a usage efficiency of the image light ray L1 from the display element 2.

The aforementioned image display device 1 includes the optical system 3 and the display element 2. This configuration can reduce absence of the pupil of the image light ray L1 in the field of view region Ac and decrease the size of the incident region 51.

### 2. Variations

Embodiments of the present disclosure are not limited to the above embodiment. The above embodiment may be modified in various ways in accordance with designs or the like to an extent that they can achieve the problem of the present disclosure. Hereinafter, some variations or modifications of the above embodiment will be listed. One or more of the variations or modifications described below may apply in combination with one or more of the others.

In one variation, the diffraction structures of the exit extension region 53 is not limited to a volume holographic element (holographic diffraction grating), but may be a surface-relief diffraction grating. The surface-relief diffraction grating may be of a reflection type. The surface-relief diffraction grating may be made of material not limited to the same material as the light guide 5 but different from the material of the light guide 5. For example, the material of the light guide 5 may be glass and the material of the surface-relief diffraction grating may be ultraviolet curable resin. In this case, the surface-relief diffraction grating can be fabricated by nanoimprint techniques. Note that, the refractive index of the exit extension region 53 is a refractive index of the material forming the surface-relief diffraction grating when the diffraction structure of the exit extension region 53 is the surface-relief diffraction grating.

In one variation, the diffraction structures of the incident region 51 and the auxiliary extension region 52 are not limited to a volume holographic element (holographic diffraction grating), but may be a surface-relief diffraction grating. In one variation, the incident region 51 and the auxiliary extension region 52 may include half mirrors.

In one variation, the propagation angle θᵢ is equal to or greater than 42° and is equal to or smaller than 50°. The angle θ, at which the second image light ray L12 emerges from the body 50 is equal to or greater than 25° and is equal to or smaller than 60°. The diffraction pitch d of the diffraction structure of the exit extension region 53 is equal to or greater than 3.02×λ/n and is equal to or smaller than 7.71×λ/n. λ is the central wavelength of the image light ray L1. n is the refractive index of the body 50. This configuration can reduce an area of the field of view region Ac where no pupil of an image light ray L1 is located, and additionally decrease the size of the incident region 51. Especially, in a case of applying to a head-up display, a usage efficiency of the image light ray L1 from the display element 2 can be improved.

In one variation, the light guide 5 always need not be positioned to guide the image light ray L2 emerging from the body 50 to the field of view region Ac as an optical image (the virtual image Iv) by reflecting the image light ray L2 by the light-transmissive member (the windshield 101). For example, the light guide 5 may be positioned so that the light guide 5 and the field of view region Ac are arranged in a straight line. This means that an optical pathway from the light guide 5 to the field of view region Ac may be a straight line.

In one variation, the projection optical system 6 may be constituted by a plurality of optical elements including a first optical element and a second optical element, rather than a single optical element. The first optical element is a compound lens where a negative meniscus lens and biconvex lens are combined, for example. The second optical element is a compound lens where a positive meniscus lens and a negative meniscus lens are combined, for example. Note that, the optical system 3 may not include the projection optical system 6.

In one variation, it is not always necessary that the projection optical system 6 and the incident region 51 are arranged in a straight line. In other words, the optical path of the image light ray L1 from the projection optical system 6 toward the incident region 51 always need not be straight. For example, the image light ray L1 from the projection optical system 6 may be reflected by a reflection plate to be incident on the incident region 51. In this arrangement, the optical path of the image light ray L1 from the projection optical system 6 toward the incident region 51 is not straight but an L-shape, for example.

In one variation, the image display device 1 may include a plurality of light guides 5 respectively corresponding to wavelengths of light included in the image light ray L1. This enables provision of a color image to a user.

In one variation, the image display device 1 may be applied to, not limited to a head-up display used in an automobile, but a movable object other than automobiles, such as, bicycles, trains, air crafts, construction machinery, and ships. Alternatively, the image display device 1 may be used in, not limited to a movable object, but amusement facilities, for example, and alternatively, in wearable terminals such as head mounted displays (HMD), medical equipment, or, stationary devices.

Additionally, in the above embodiment, the explanation is made to the display element 2 and the optical system 3 which allow a user to visually perceive the virtual image Iv as one example of an optical image. In the present embodiment, an optical image which the display element 2 allows a user to visually perceive is not limited to the virtual image Iv, but a real image, for example. In one instance, the display element 2 may be configured to use the optical system 3 of a pupil expansion type similar to the above, to form a real image between the light-transmissive member such as the windshield 101, and the user D. Such display of real images are useful in amusement application, for example. In a case where such a real image is visually perceived as an optical image, polarization inside the light guide 5 may be considered to affect brightness unevenness similar to the case of the aforementioned virtual image Iv. The display element 2 and the optical system 3 according to the present disclosure can reduce brightness unevenness by controlling the polarization state similar to the above embodiment, thereby suppressing a variation of image quality of a real image.

### 3. Aspects

As apparent from the above embodiment and variations, the present disclosure includes the following aspects. Hereinafter, reference signs in parenthesis are attached for the purpose of clearly showing correspondence with the embodiments only.

A first aspect is an optical system and includes a light guide (5) for guiding an image light ray (L1) which is output from a display element (2) and forms an image, to a field of view region (Ac) of a user (D) as an optical image (the virtual image Iv). The light guide (5) includes: a body (50) having a plate shape; an incident region (51) formed at the body (50) and allowing the image light ray (L1) to enter the body (50) so that the image light ray (L1) propagates inside the body (50); and an exit extension region (53) formed at the body (50) and including a diffraction structure dividing an image light ray (L1B) propagating in a first propagation direction intersecting a thickness direction of the body (50), into a plurality of image light rays (L2) propagating in a second propagation direction intersecting the first propagation direction, in the first propagation direction, and allowing them to emerge from the body (50). The exit extension region (53) divides an image light ray (L1B, L11, L13) which propagates in the first propagation direction and is incident on the exit extension region (53), into a first image light ray (L11), a second image light ray (L12), and a third image light ray (L13), in a predetermined plane (P1) including the first propagation direction and the second propagation direction. The first image light ray (L11) emerges from the exit extension region (53) at a first angle equal to a propagation angle of an image light ray (L1B) propagating from the incident region (51) to the exit extension region (53) in the predetermined plane (P1) to propagate inside the body (50). The second image light ray (L12) emerges from the exit extension region (53) at a second angle different from the first angle to emerge from the body (50). The third image light ray (L13) emerges from the exit extension region (53) at a third angle different from the first angle and the second angle to propagate inside the body (50). The exit extension region (53) includes an overlap part (53a) on which the first image light ray (L11) and the third image light ray (L13) are incident under a condition where they partially overlap with each other in the predetermined plane (P1). A difference between optical paths of the first image light ray (L11) and the third image light ray (L13) incident on the overlap part (53a) is longer than a coherence length of the image light ray (L1). This aspect can improve the filling factor of the pupil of the image light ray (L1) in the field of view region (Ac) and decrease the size of the incident region (51).

A second aspect is an optical system (3) based on the first aspect. In this aspect, formulae (1) and (2) are satisfied.

$$\begin{matrix}[ FORMULA 26 ] & \\ \frac{\frac{1}{n} sin {θ}_{o} + 1}{2} > sin {θ}_{i} > \frac{1}{n} & ( 1 )\end{matrix}$$

$$\begin{matrix}[ FORMULA 27 ] & \\ \vert {m}_{1} \times \frac{2 T}{cos {θ}_{i}} - {m}_{2} \times \frac{2 T}{cos {θ}_{p}} \vert > \frac{{( λ / n )}^{2}}{Δλ / n} & ( 2 )\end{matrix}$$

0; is the propagation angle [°], θₒ is an angle [°] at which the second image light ray (L12) emerges from the body (50), θₚ is the third angle, n is a refractive index of the body (50), T is a thickness [μm] of the body (50), m₁ is a number of times of reciprocation of the first image light ray (L11) inside the exit extension region (53) when incident on the overlap part (53a), m₂ is a number of times of reciprocation of the third image light ray (L13) inside the exit extension region (53) when incident on the overlap part (53a), λ is a central wavelength [μm] of the image light ray (L1), and Δλ is a line width [μm] of the image light ray (L1). This aspect can improve the filling factor of the pupil of the image light ray (L1) in the field of view region (Ac) and decrease the size of the incident region (51).

A third aspect is an optical system (3) based on the first or second aspect. In this aspect, when a range of the propagation angle is equal to or greater than θᵢ₀−θ_{f2} and is equal to or smaller than θᵢ₀+θ_{f1}, a formula (3) is satisfied.

$$\begin{matrix}[ FORMULA 28 ] & \\ \vert \frac{λ}{n} \times \frac{1}{sin ( {θ}_{i 0} - {θ}_{f 2} ) - sin ( {θ}_{i 0} + {θ}_{f 1} )} \vert > d > \vert \frac{λ}{n} \times \frac{1}{sin {θ}_{i 0} - 1} \vert & ( 3 )\end{matrix}$$

d is a diffraction pitch [μm] of the diffraction structure of the exit extension region (53), n is a refractive index of the body (50), λ is a central wavelength [μm] of the image light ray (L1), θ_{i o} is a propagation angle [°] of a central light beam of the image light ray (L1), and θ_{f 1} and θ_{f 2} are positive values [°]. This aspect can improve the filling factor of the pupil of the image light ray (L1) in the field of view region (Ac) and decrease the size of the incident region (51).

A fourth aspect is an optical system (3) based on any one of the first to third aspects. In this aspect, part of the exit extension region (53) which divides the image light ray into the first image light ray (L11), the second image light ray (L12) and the third image light ray (L13) is at least included in an end on a side of the incident region (51), of the exit extension region (53) in an optical path of the image light ray (L1) from the incident region (51) to the exit extension region (53). This aspect can improve the filling factor of the pupil of the image light ray (L1) in the field of view region (Ac) and decrease the size of the incident region (51).

A fifth aspect is an optical system (3) based on the fourth aspect. In this aspect, the exit extension region (53) divides the third image light ray (L13) which has reciprocated at an arbitrary number of times inside the exit extension region (53), into the first image light ray (L11), the second image light ray (L12), and the third image light ray (L13). This aspect can improve the filling factor of the pupil of the image light ray (L1) in the field of view region (Ac) and decrease the size of the incident region (51).

A sixth aspect is an optical system (3) based on any one of the first to fifth aspects. In this aspect, an irradiated region (A10) of the image light ray (L1) in the incident region (51) has a first dimension (a1) in the first propagation direction and a second dimension (a2) in a direction perpendicular to each of the thickness direction of the body (50) and the first propagation direction, and the first dimension (a1) is smaller than the second dimension (a2). This aspect can improve the filling factor of the pupil of the image light ray (L1) in the field of view region (Ac) and decrease the size of the incident region (51).

A seventh aspect is an optical system (3) based on any one of the first to sixth aspects. In this aspect, the light guide (5) further includes an auxiliary extension region (52) which is formed at the body (50) and includes a diffraction structure dividing an image light ray (LIA) propagating in a predetermined direction inside the body (50) by the incident region (51), into a plurality of image light rays (L1B) propagating in the first propagation direction, in the predetermined direction, and allowing them to travel toward the exit extension region (53). This aspect allows expansion of a pupil in a plurality of different directions.

An eighth aspect is an optical system (3) based on the seventh aspect. In this aspect, the predetermined direction corresponds to a horizontal direction of the field of view region (Ac), and the first propagation direction corresponds to a vertical direction of the field of view region (Ac). This aspect enables pupil expansion in the horizontal direction and the vertical direction, of the field of view region (Ac).

A ninth aspect is an optical system (3) based on any one of the first to eighth aspects. In this aspect, the light guide (5) is positioned to guide the image light ray (L2) emerging from the body (50) to the field of view region (Ac) as the optical image (the virtual image Iv) by reflecting the image light ray (L2) by a light-transmissive member (the windshield 101). This aspect allows application to head-up displays.

A tenth aspect is an optical system (3) based on the ninth aspect. In this aspect, the body (50) includes a first surface (50a) and a second surface (50b) in the thickness direction. The incident region (51) allows the image light ray (L1) incident on the first surface (50a) in a first inclined direction inclined relative to a normal line of the first surface (50a), to enter the body (50) so that the image light ray (L1) propagates inside the body (50). The exit extension region (53) allows the plurality of image light rays (L1C) propagating in the second propagation direction to emerge from the second surface (50b) in a second inclined direction inclined relative to a normal line of the second surface (50b). This aspect can improve the filling factor of the pupil of the image light ray (L1) in the field of view region (Ac) and decrease the size of the incident region (51).

An eleventh aspect is an optical system (3) based on the tenth aspect. In this aspect, the first inclined direction and the second inclined direction are parallel to each other. This aspect can improve the filling factor of the pupil of the image light ray (L1) in the field of view region (Ac) and decrease the size of the incident region (51).

A twelfth aspect is an optical system (3) based on any one of the ninth to eleventh aspects. In this aspect, the propagation angle is equal to or greater than 42° and is equal to or smaller than 50°. An angle at which the second image light ray (L12) emerges from the body (50) is equal to or greater than 25° and is equal to or smaller than 60°. A diffraction pitch of the diffraction structure of the exit extension region (53) is equal to or greater than 3.02×λ/n and is equal to or smaller than 7.71×λ/n. λ is a central wavelength of the image light ray (L1). n is a refractive index of the body (50). This aspect can improve the filling factor of the pupil of the image light ray (L1) in the field of view region (Ac) and decrease the size of the incident region (51).

A thirteenth aspect is an optical system (3) based on any one of the first to twelfth aspects. In this aspect, the diffraction structure of the exit extension region (53) is a volume holographic element positioned inside the body (50) This aspect can easily increase a size of the exit expansion region (53).

A fourteenth aspect is an optical system (3) based on any one of the first to thirteenth aspects. In this aspect, the optical system (3) further includes a projection optical system (6) allowing the image light ray (L1) to be incident on the incident region (51) of the light guide (5) as a substantial collimate light ray. This aspect can further improve a usage efficiency of the image light ray (L1) from the display element (2).

A fifteenth aspect is an image display device (1) and includes an optical system (3) based on any one of the first to fourteenth aspects, and the display element (2). This aspect can improve the filling factor of the pupil of the image light ray (L1) in the field of view region (Ac) and decrease the size of the incident region (51).

The aforementioned second to fourteenth aspects are optional.

As above, as examples of techniques in the present disclosure, the embodiments are described. For this purpose, the attached drawings and the description are provided. Therefore, components described in the attached drawings and the description may include not only components necessary for solving problems but also components which are unnecessary for solving problems but useful for exemplifying the above techniques. Note that, such unnecessary components should not be considered as necessary just for the reason why such unnecessary components are described in the attached drawings and the description. Further, the embodiment described above is just prepared for exemplifying the techniques in the present disclosure and thus may be subjected to various modification, replacement, addition, omission, or the like within the scope defined by claims and those equivalent range.

### INDUSTRIAL APPLICABILITY

The present disclosure is applicable to optical systems and image display devices. In more detail, the present disclosure is applicable to an optical system for guiding an image light ray from a display element to a field of view region of a user as an optical image, and an image display device including this optical system.

### REFERENCE SIGNS LIST

1 Image Display Device
2 Display Element
3 Optical System
5 Light Guide
50 Body
50a First Surface
50b Second Surface
51 Incident Region
52 Auxiliary Extension Region
53 Exit Extension Region
6 Projection Optical System
100 Movable Object
101 Windshield (Light-transmissive Member)
Ac Field of view Region
D User
Iv Virtual Image (Optical Image)
L1, L1A, L1B, L1C, L2 Image Light Ray
L11 First Image Light Ray
L12 Second Image Light Ray
L13 Third Image Light Ray
P1 Predetermined Plane

1. An optical system comprising a light guide for guiding an image light ray which is output from a display element and forms an image, to a field of view region of a user as an optical image,
the light guide including:
a body having a plate shape;
an incident region formed at the body and allowing the image light ray to enter the body so that the image light ray propagates inside the body; and
an exit extension region formed at the body and including a diffraction structure dividing an image light ray propagating in a first propagation direction intersecting a thickness direction of the body, into a plurality of image light rays propagating in a second propagation direction intersecting the first propagation direction, in the first propagation direction, and allowing them to emerge from the body,
the exit extension region dividing an image light ray which propagates in the first propagation direction and is incident on the exit extension region, into a first image light ray, a second image light ray, and a third image light ray, in a predetermined plane including the first propagation direction and the second propagation direction,
the first image light ray emerging from the exit extension region at a first angle equal to a propagation angle of an image light ray propagating from the incident region to the exit extension region in the predetermined plane to propagate inside the body;
the second image light ray emerging from the exit extension region at a second angle different from the first angle to emerge from the body;
the third image light ray emerging from the exit extension region at a third angle different from the first angle and the second angle to propagate inside the body;
the exit extension region including an overlap part on which the first image light ray and the third image light ray are incident under a condition where they partially overlap with each other in the predetermined plane, and
a difference between optical paths of the first image light ray and the third image light ray incident on the overlap part being longer than a coherence length of the image light ray.

2. The optical system according to claim 1, satisfying formulae (1) and (2),
$$\frac{\frac{1}{n} sin {θ}_{o} + 1}{2} > sin {θ}_{i} > \frac{1}{n} \qquad ( 1 )$$
$$\vert {m}_{1} \times \frac{2 T}{cos {θ}_{i}} - {m}_{2} \times \frac{2 T}{cos {θ}_{p}} \vert > \frac{{( λ / n )}^{2}}{Δλ / n} \qquad ( 2 )$$
θᵢ being the propagation angle [°];
θₒ being an angle [°] at which the second image light ray emerges from the body;
θₚ being the third angle;
n being a refractive index of the body;
T being a thickness [μm] of the body;
m₁ being a number of times of reciprocation of the first image light ray inside the exit extension region when incident on the overlap part;
m₂ being a number of times of reciprocation of the third image light ray inside the exit extension region when incident on the overlap part;
λ being a central wavelength [μm] of the image light ray; and
Δλ being a line width [μm] of the image light ray.

3. The optical system according to claim 1, when a range of the propagation angle is equal to or greater than θ_{i 0}−θ_{f 2} and is equal to or smaller than θ_{i 0}+θ_{f 1}, satisfying a formula (3),
$$\vert \frac{λ}{n} \times \frac{1}{sin ( {θ}_{i 0} - {θ}_{f 2} ) - sin ( {θ}_{i 0} + {θ}_{f 1} )} \vert > d > \vert \frac{λ}{n} \times \frac{1}{sin {θ}_{i 0} - 1} \vert , \qquad ( 3 )$$
wherein:
d is a diffraction pitch [μm] of the diffraction structure of the exit extension region;
n is a refractive index of the body;
λ is a central wavelength [μm] of the image light ray;
θ_{i o} is a propagation angle [°] of a central light beam of the image light ray; and
θ_{f 1} and θ_{f 2} are positive values [°].

4. The optical system according to claim 1, wherein part of the exit extension region which divides the image light ray into the first image light ray, the second image light ray and the third image light ray is at least included in an end on a side of the incident region, of the exit extension region in an optical path of the image light ray from the incident region to the exit extension region.

5. The optical system according to claim 4, wherein the exit extension region divides the third image light ray which has reciprocated at an arbitrary number of times inside the exit extension region, into the first image light ray, the second image light ray, and the third image light ray.

6. The optical system according to claim 1, wherein:
an irradiated region of the image light ray in the incident region has a first dimension in the first propagation direction and a second dimension in a direction perpendicular to each of the thickness direction of the body and the first propagation direction; and
the first dimension is smaller than the second dimension.

7. The optical system according to claim 1, further comprising
an auxiliary extension region formed at the body and including a diffraction structure dividing an image light ray propagating in a predetermined direction inside the body by the incident region, into a plurality of image light rays propagating in the first propagation direction, in the predetermined direction, and allowing them to travel toward the exit extension region.

8. The optical system according to claim 7, wherein:
the predetermined direction corresponds to a horizontal direction of the field of view region; and
the first propagation direction corresponds to a vertical direction of the field of view region.

9. The optical system according to claim 1, wherein the light guide is positioned to guide the image light ray emerging from the body to the field of view region as the optical image by reflecting the image light ray by a light-transmissive member.

10. The optical system according to claim 9, wherein:
the body includes a first surface and a second surface in the thickness direction;
the incident region allows the image light ray incident on the first surface in a first inclined direction inclined relative to a normal line of the first surface of the body, to enter the body so that the image light ray propagates inside the body; and
the exit extension region allows the plurality of image light rays propagating in the second propagation direction to emerge from the second surface of the body in a second inclined direction inclined relative to a normal line of the second surface of the body.

11. The optical system according to claim 10, wherein the first inclined direction and the second inclined direction are parallel to each other.

12. The optical system according to claim 9, wherein:
the propagation angle is equal to or greater than 42° and is equal to or smaller than 50°;
an angle at which the second image light ray emerges from the body is equal to or greater than 25° and is equal to or smaller than 60°;
a diffraction pitch of the diffraction structure of the exit extension region is equal to or greater than 3.02×λ/n and is equal to or smaller than 7.71×λ/n;
λ is a central wavelength of the image light ray; and
n is a refractive index of the body.

13. The optical system according to claim 1, wherein the diffraction structure of the exit extension region is a volume holographic element positioned inside the body.

14. The optical system according to claim 1, further comprising
a projection optical system allowing the image light ray to be incident on the incident region of the light guide as a substantial collimate light ray.

15. An image display device comprising:
the optical system according to claim 1; and
the display element.
